(19) United States
(12) Patent Application Publication
(10) Pub. No.: US 2021/0195899 A1
(43) Pub. Date: Jul. 1, 2021

(54) EMULSIFIABLE CONCENTRATE FORMULATIONS OF SDHI FUNGICIDES

(71) Applicants: FMC Corporartion, Philadelphia, PA (US); FNC AGRO Singapore Pte. Ltd., Singapore (SG)

(72) Inventors: Laibin B. YAN, North Wales, PA (US); Debra YUHAS, Wrighstown, NJ (US); Ubiratan F. DE SOUSA, Washington Crossing, PA (US); David T. BIRD, Plainsboro, NJ (US); Soren GYLLING, Lemving (DK); Frank ZAWACKI, Lemving (DK)

(21) Appl. No.: 17/045,178

(22) PCT Filed: Apr. 4, 2019
(86) PCT No.: PCT/US19/25854

§ 371 Date: Oct. 4, 2020

Related U.S. Application Data
(60) Provisional application No. 62/652,426, filed on Apr. 4, 2018.

(51) Int. Cl. A01N 43/56; A01N 25/02; A01N 43/653

(52) U.S. Cl. CPC A01N 43/56; A01N 43/653; A01N 25/02

(57) ABSTRACT

An emulsifiable concentrate formulation for the protection of agricultural crops comprising: (A) a succinate dehydrogenase inhibitor (SDHI) and (B) a phosphoric ester of the formula (R¹O)(R²O)(R³O)P═O, wherein R¹ represents alkyl having 4 to 12 carbon atoms, or optionally substituted phenyl, and R² and R³ independently represent alkyl having 2 to 8 carbon atoms, or optionally substituted phenyl. The composition may also comprise surfactants and/or emulsifiers, optionally additional solvents such as esters or amides, and/or an additional fungicide.

### FIELD OF THE INVENTION

The invention relates to emulsifiable concentrate formulations comprising carboxamide fungicide compositions for the protection of agricultural crops and use thereof. This invention also relates to a method for improving leaf penetration of the carboxamide fungicides.

### BACKGROUND OF THE INVENTION

Certain carboxamides are known inhibitors of succinate dehydrogenase (SDH) and are useful as fungicides to control pathogenic fungi and/or nematodes in crops. Succinate dehydrogenase inhibitors (SDHIs), also known as complex II inhibitors, include for example fluopyram, bixafen, penflufen, sedaxane and isopyrazam (See U.S. Pat. No. 9,591,856). Aminoindane amides such as the N-indanyl-pyrazolecarboxamides (U.S. Pat. No. 9,192,160) are also SDHIs. A notable SDHI is 3-difluoromethyl-N-(7-fluoro-1,1,3-trimethyl-4-indanyl)-1-methyl-4-pyrazolecarboxamide (U.S. Pat. No. 9,192,160 and US Patent Application Publication US2015/0164076).

In the application of fungicidal products for agricultural use, it is widely known to combine two or more products having a different mechanism of action and/or a different biological target, to broaden the action range of the mixtures with respect to one of the products used individually and to prevent the occurrence of resistance phenomena from the harmful organisms, phenomena which over time tend to reduce the effectiveness of the fungicidal products used.

Compositions of fungicidal N-indanyl-1-methyl-3-(halo)alkyl-4-pyrazolecarboxamides with fungicidal or insecticidal compounds such as azoles, strobilurins, acylalanines, phenylpyrroles, chlorothalonil, dithiocarbamates, abamectin, insecticidal diamides, neonicotinoids, sulfoxaflor, pyrethroids, carbamates, phenylpyrazoles, are described in patent applications WO2011/135833, WO2011/135835, WO2011/135836, WO2011/135837, WO2011/135838, WO2011/135839, WO2011/135827, WO2011/135828, WO2011/135830, WO2011/135831, WO2011/135832, WO2011/135834, and WO2011/135840. Azoles such as azaconazole, epiconazole, hexaconazole, prothioconazole and tebuconazole are notable mixing partners with SDHIs.

To enable their biological action, systemic agriculturally active compounds—particularly systemic insecticides and fungicides—are applied in formulations that allow the active compounds to be taken up by the plant/the target organisms. Accordingly, systemic agriculturally active compounds are often formulated as an emulsifiable concentrate (EC), as a soluble liquid (SL) and/or as an oil-based suspension concentrate (OD). In an EC formulation and in an SL formulation, the active compound is present in dissolved form; in an OD formulation, the active compound is present as a solid. In general, suspension concentrates (SC) or water-dispersible granules (WDG) are also feasible. However, other types of formulation where the active compound is present in a water-dispersible form are also envisioned. There are limited water insoluble solvents available for an EC formulation of carboxamide SDHIs that will help prevent crystal formation during storage of the composition and upon dilution at field application rates.

To achieve a satisfactory biological action when using formulations of agriculturally active compounds, it is usually necessary for the active compound to be combined with an additive. An additive, as the term is used herein, is a component that improves the biological action of the active compound, without the component for its part having a biological action. Particularly, a penetrant additive may permit/facilitate the uptake of the active compound into the leaf or other plant part.

Some water-based suspension concentrates of agriculturally active compounds comprising penetrants are known. WO05/036963 describes formulations of this type which, in addition to certain fungicides, comprise at least one penetrant from the group of the alkanolethoxylates. WO99/060851 describes various alkanolethoxylates based on fatty alcohols.

A disadvantage of the formulations mentioned above with penetrants is the fact that, in particular in the case of application to leaves, fruits or other parts of plants in sensitive crop plants, such as pome fruit (for example Malus domestica, Pyrus communis), stone fruit (Prunus armeniaca, Prunus domestica, Prunus persica), citrus crops, vegetables, such as, for example, bell peppers (Capsicum annuum) and cantalopes (Cucumis melo), and also ornamental plants, such as roses, the spray liquor residue left after application and drying of the spray liquid may cause damage to the plants.

The formation of plant damage is complex and can be traced back to the penetration of penetrants such as alkanolethoxylates in particular at the edge of the spray droplets on the plant. This may result in high local concentrations of additive and/or active compound, causing necrotic rings or circles to appear on the treated plant surface, the area of some of which will extend owing to the destruction of tissue.

It can be desirable to provide formulations of agriculturally active compounds such as succinate dehydrogenase inhibitors (SDHI) with penetrants wherein application of the formulation does not cause damage to the plants.

### SUMMARY OF THE INVENTION

The invention provides a composition for the protection of agricultural crops comprising or consisting essentially of: (A) a succinate dehydrogenase inhibitor (SDHI) and (B) a phosphoric ester of the formula (R¹O)(R²O)(R³O)P═O, wherein: R¹ represents straight-chain or branched alkyl having 4 to 12 carbon atoms, or phenyl optionally substituted with 1-3 C₁-C₄ alkyl groups; R² represents straight-chain or branched alkyl having 2 to 8 carbon atoms, or phenyl optionally substituted with 1-3 C₁-C₄ alkyl groups; and R³ represents straight-chain or branched alkyl having 2 to 8 carbon atoms, or phenyl optionally substituted with 1-3 C₁-C₄ alkyl groups.

In another aspect the invention provides a composition for the protection of agricultural crops comprising or consisting essentially of: (A) a succinate dehydrogenase inhibitor (SDHI); and (B) a trialkyl phosphoric ester of the formula (R¹O)(R²O)(R³O)P═O, wherein the phosphoric ester comprises at least one phosphoric ester selected from: tris-(2-ethylhexyl)phosphate; tri-n-octyl phosphate; or tri-iso-butyl phosphate; or any combination thereof.

This invention also provides a method for controlling phytopathogenic fungi in agricultural crops that comprises applying an effective dose of a composition, or any embodiment thereof, on: (a) one or more parts of the plants to be protected; and/or (b) the seeds of said plants before sowing; and/or (c) on the soil in which said plants grow, wherein the composition comprises: (A) a succinate dehydrogenase inhibitor (SDHI); and, (B) a phosphoric ester of the formula (R¹O)(R²O)(R³O)P═O, wherein: R¹ represents straight-chain or branched alkyl having 4 to 12 carbon atoms, or phenyl optionally substituted with 1-3 C₁-C₄ alkyl groups; R² represents straight-chain or branched alkyl having 2 to 8 carbon atoms, or phenyl optionally substituted with 1-3 C₁-C₄ alkyl groups; and R³ represents straight-chain or branched alkyl having 2 to 8 carbon atoms, or phenyl optionally substituted with 1-3 C₁-C₄ alkyl groups.

The invention also provides a method for the control of phytopathogenic fungi in agricultural crops comprising the use of the composition or any embodiment thereof, wherein the composition comprises: (A) a succinate dehydrogenase inhibitor (SDHI) and (B) a phosphoric ester of the formula (R¹O)(R²O)(R³O)P═O, wherein: R¹ represents straight-chain or branched alkyl having 4 to 12 carbon atoms, or phenyl optionally substituted with 1-3 C₁-C₄ alkyl groups; R² represents straight-chain or branched alkyl having 2 to 8 carbon atoms, or phenyl optionally substituted with 1-3 C₁-C₄ alkyl groups; and R³ represents straight-chain or branched alkyl having 2 to 8 carbon atoms, or phenyl optionally substituted with 1-3 C₁-C₄ alkyl groups.

This invention also provides an improved method for applying SDHIs and treating targeted plants by increasing penetration of a succinate dehydrogenase inhibitor (SDHI) into a plant or plant part, as measured by uptake of the SDHI by the plant, comprising: (1) mixing the SDHI with a penetrant comprising a phosphoric ester of the formula (R¹O)(R²O)(R³O)P═O, wherein: R¹ represents straight-chain or branched alkyl having 4 to 12 carbon atoms, or phenyl optionally substituted with 1-3 C₁-C₄ alkyl groups; R² represents straight-chain or branched alkyl having 2 to 8 carbon atoms, or phenyl optionally substituted with 1-3 C₁-C₄ alkyl groups; and R³ represents straight-chain or branched alkyl having 2 to 8 carbon atoms, or phenyl optionally substituted with 1-3 C₁-C₄ alkyl groups; and, (2) applying the mixture to the plant or plant part. Uptake of the SDHI by the plant can be determined by any conventional means.

Embodiments of the methods described above include those wherein: the method wherein the SDHI and the penetrant are mixed in a single formulation comprising at least one formulation additive; the SDHI and the penetrant are mixed with water as a tank mix; the phosphoric ester comprises tris-(2-ethyl-hexyl)phosphate; the phosphoric ester comprises tris-(2-ethyl-hexyl)phosphate and tri-iso-butyl phosphate.

### DETAILED DESCRIPTION OF THE INVENTION

It has been found that trialkyl phosphoric esters as described herein facilitate the uptake of SDHI fungicides but, surprisingly and in contrast to other penetrants typically employed, do not lead to necrosis.

SDHI fungicides wherein their uptake, or penetration, is improved when mixed with the phosphoric esters described herein include carboxamide SDHIs. It has been discovered that for carboxamide SDHIs an emulsifiable concentrate (EC) formulation provides significantly better disease control compared to other types of formulations. SDHI fungicides described and used effectively in the present invention can be present either as a singular, or sole, active fungicide or can be combined with other optional fungicides to provide effective mixtures with the trialkyl phosphoric esters described herein.

Described herein are emulsifiable concentrate formulations of SDHI fungicides and phosphoric esters, optionally with additional fungicides. Accordingly, the invention provides a composition for the protection of agricultural crops comprising: (A) a succinate dehydrogenase inhibitor (SDHI) and (B) a phosphoric ester of the formula (R¹O)(R²O)(R³O)P═O, wherein R¹ represents straight-chain or branched alkyl having 4 to 12 carbon atoms, or phenyl optionally substituted with 1-3 C₁-C₄ alkyl groups, R² represents straight-chain or branched alkyl having 2 to 8 carbon atoms, or phenyl optionally substituted with 1-3 C₁-C₄ alkyl groups, and R³ represents straight-chain or branched alkyl having 2 to 8 carbon atoms, or phenyl optionally substituted with 1-3 C₁-C₄ alkyl groups. The compositions may also comprise surfactants and/or emulsifiers, and optionally additional solvents such as esters and amides.

The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

### Phosphate Esters

Water insoluble trialkyl phosphates (phosphoric esters) shown in Formula I below, or alternatively described as (R¹O)(R²O)(R³O)P═O, dissolve carboxamide SDHI fungicides such as Formula II and are useful for increasing the ability of an agriculturally active agent to penetrate a plant or plant parts.

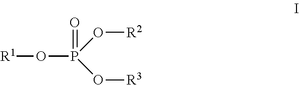

Trialkyl phosphates are not new and are known to have been used as defoamers (see U.S. Pat. No. 3,873,689) and crystallization inhibitors (see U.S. Pat. No. 5,476,845). The use of phosphoric esters of Formula I in aqueous formulations with SDHI fungicides has not been previously described, but the applicant has discovered several advantages of such use, including some advantages that are surprising. For example, the phosphoric esters of Formula I are substances whose handling is substantially problem-free, and which are also available in substantial amounts. Furthermore, the use of phosphoric esters prevents clogging of the filters and of the nozzles of the spray equipment due to undesired crystallization of the active ingredient when aqueous formulations containing SDHIs are applied by spraying. Trialkyl phosphates can: (i) improve rain-fastness and leaf penetration as compared to other formulations not containing phosphate esters; (ii) provide lower phytotoxicity to crops sprayed with the formulations; and (iii) provide good operator safety, such as reduced eye irritation.

The phosphate esters of general Formula I can be used according to the invention, wherein R¹ represents straight-chain or branched alkyl having 4 to 12 carbon atoms, or phenyl optionally substituted with 1-3 C₁-C₄ alkyl groups, R² represents straight-chain or branched alkyl having 2 to 8 carbon atoms, or phenyl optionally substituted with 1-3 C₁-C₄ alkyl groups, and R³ represents straight-chain or branched alkyl having 2 to 8 carbon atoms, or phenyl optionally substituted with 1-3 C₁-C₄ alkyl groups.

R¹ preferably represents: n-butyl; iso-butyl; sec-butyl; tert-butyl; n-pentyl; n-hexyl; 2-ethyl-hexyl; n-heptyl; n-octyl; iso-octyl; n-nonyl; iso-nonyl; n-decyl; n-dodecyl; iso-dodecyl; phenyl; 3-methyl phenyl; 2,4-dimethyl phenyl; isopropyl phenyl; or t-butyl phenyl.

R² preferably represents: n-butyl; iso-butyl; sec-butyl; tert-butyl; n-pentyl; n-hexyl; 2-ethyl-hexyl; n-heptyl; n-octyl; iso-octyl; phenyl; 3-methyl phenyl; 2,4-dimethyl phenyl; isopropyl phenyl; or t-butyl phenyl.

R³ preferably represents: n-butyl; iso-butyl; sec-butyl; tert-butyl; n-pentyl; n-hexyl; 2-ethyl-hexyl; n-heptyl; n-octyl; iso-octyl; phenyl; 3-methyl phenyl; 2,4-dimethyl phenyl; isopropyl phenyl; or t-butyl phenyl.

The following are specific examples of phosphoric esters that can be used according to the invention: trixylenyl phosphate, butylated phenol phosphate, tris(isopropylphenyl) phosphate, cresyl diphenyl phosphate, isopropylphenyl diphenyl phosphate, t-butylphenyl diphenyl phosphate, 2-ethylhexyl, diphenyl phosphate, isodecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate (TEHP), and tri-iso-butyl phosphate (TIBP), or combinations thereof.

Tris-(2-ethylhexyl)phosphate (TEHP), tri-n-octyl phosphate or and tri-iso-butyl phosphate (TIBP) can be more preferred. Tri-isobutyl phosphate is a very strong, polar solvent and is a good wetting agent. Tris(2-ethylhexyl)phosphate also increases penetration of the SDHI into the leaf. In some embodiments TIBP can be preferred. In some embodiments, it can be preferable to combine tris-(2-ethyl-hexyl)phosphate and tri-iso-butyl phosphate.

It has been found that the solvency power of the trialkyl phosphoric esters enables total active ingredient loading of up to about 20 wt % of the formulation, which is higher active ingredient loading as compared to previous emulsifiable concentrates of SDHIs. The formulations described herein also promote synergy of biological efficacy on the target fungicidal diseases when the SDHI is combined with an additional fungicide such as an azole fungicide.

The phosphoric esters are included in the compositions of the present invention in a range of from about 10 to about 80% by weight, based on the weight of the composition, with the proviso that the composition comprises from about 50 to about 85 wt % of total solvent, based on the weight of the composition, wherein the total solvent is the combined amount of phosphoric ester plus other solvent present in the composition. Alternatively, the phosphoric esters can comprise from about 30 to about 80 wt % of the composition, or from about 35 to about 75 wt %, or from about 35 to about 70 wt % of the composition, with the proviso that the composition comprises from about 50 to about 85 wt % of total solvent, based on the weight of the composition, wherein the total solvent is the combined amount of phosphoric ester plus other solvent present in the composition.

The formulations of this invention provide better efficacy on the target diseases, lower use rates, rainfastness and leaf penetration, and reduced spray drift. The use of phosphoric esters in the formulations also provides good handling and storage stability, acceptable toxicity profiles in terms of oral toxicity, dermal and eye irritation, and skin sensitization, and acceptable phytotoxicity profiles on the target crops.

### SDH Inhibitors

The SDHI may comprise an amide of 4-aminoindane.

Examples of amides of 4-aminoindane that are particularly interesting for their activity include: 3-difluoromethyl-N-(7-fluoro-1,1,3-trimethyl-4-indanyl)-1-methyl-4-pyrazolecarboxamide; 4-difluoromethyl-N-(7-fluoro-1,1,3-trimethyl-4-indanyl)-2-methyl-5-thiazolecarboxamide; 3-difluoromethyl-1-methyl-N-(1,1,3,7-tetramethyl-4-indanyl)-pyrazolecarboxamide; 4-difluoromethyl-2-methyl-N-(1,1,3,7-tetramethyl-4-indanyl)-5-thiazolecarboxamide; 3-difluoromethyl-1-methyl-N-(7-methoxy-1,1,3-trimethyl-4-indanyl)-4-pyrazolecarboxamide; 4-difluoromethyl-2-methyl-N-(7-methoxy-1,1,3-trimethyl-4-indanyl)-5-thiazolecarboxamide; 3-difluoromethyl-1-methyl-N-(7-methylthio-1,1,3-trimethyl-4-indanyl)-4-pyrazolecarboxamide; 4-difluoromethyl-2-methyl-N-(7-methylthio-1,1,3-trimethyl-4-indanyl)-5-thiazolecarboxamide; 3-difluoromethyl-1-methyl-N-(7-trifluoromethoxy-1,1,3-trimethyl-4-indanyl)-4-pyrazolecarboxamide; 4-difluoromethyl-2-methyl-N-(7-trifluoromethoxy-1,1,3-trimethyl-4-indanyl)-5-thiazolecarboxamide; 3-difluoromethyl-N-(7-fluoro-1,1,3-trimethyl-4-indanyl)-4-furazancarboxamide; 4-difluoromethyl-N-(7-fluoro-1,1,3-trimethyl-4-indanyl)-2-methylthio-5-pyrimidinecarboxamide; 3-difluoromethyl-N-(7-chloro-1,1,3-trimethyl-4-indanyl)-1-methyl-4-pyrazolecarboxamide (Fluindapyr); 3-difluoromethyl-N-(7-chloro-1,1-diethyl-3-methyl-4-indanyl)-1-methyl-4-pyrazolecarboxamide; and 4-difluoromethyl-N-(7-fluoro-1,1,3-trimethyl-4-indanyl)-5-thiadiazolecarboxamide.

A particularly preferred amide of 4-aminoindane is 3-difluoromethyl-N-(7-fluoro-1,1,3-trimethyl-4-indanyl)-1-methyl-4-pyrazolecarboxamide, of Formula II. A provisionally approved common name for Formula II is Fluindapyr.

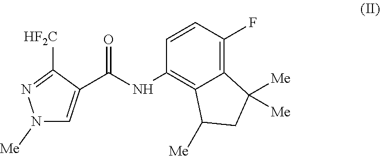

The compound of Formula II (that is, Fluindapyr) can be prepared by either: 1) acid isomerization of N-(3-difluoromethyl-1-methyl-H-4-pyrazolecarbonyl)-6-fluoro-2,2,4-trimethyl-1,2,3,4-tetrahydro-quinoline; or, 2) condensation of 3-difluoromethyl-1-methyl-1H-pyrazole-4-carboxylic acid or its derivative, with 7-fluoro-1,1,3-trimethyl-4-aminoindane as described in US Patent Application Publication US2015/0164076.

The compound of Formula II contains an asymmetric carbon atom in position 3 of the indanyl group and it is usually obtained as a racemic mixture of the two enantiomers having configurations R and S (molar ratio R:S equal to 1:1). However, it is possible to prepare mixtures of the two enantiomers of the compound of formula (II) wherein the ratio of R:S is different from 1:1 (enriched mixtures). Moreover, it is possible to prepare either of the single enantiomers R or S of Fluindapyr in substantially pure form (>99% by weight). The enantiomerically enriched mixtures and the substantially pure single enantiomers can be prepared as described in US Patent Application Publication US2015/0164076.

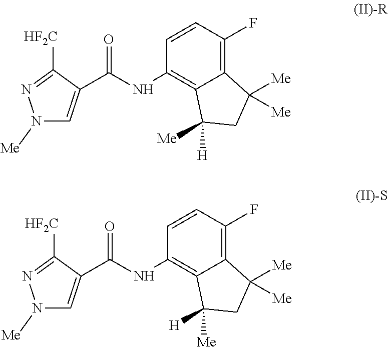

In the compositions of this invention the compound of Formula II can be a racemic mixture, (II)-RS, or an enriched mixture of one of the two enantiomers, for example an 8:2 mixture of the R:S mixture, or even a substantially pure specific enantiomer (II)-R or (II)-S. In the case of enriched mixtures of the compound of Formula II, those enriched in the R-enantiomer are preferred, preferably with a weight ratio of the two enantiomers (R:S) ranging from 51:49 to 99.99:0.01, such as 80:20. Among the two enantiomeric forms of the compound of formula II, the substantially pure R isomer is preferred.

As used herein, an SDH inhibitor that does not comprise an indanyl moiety is designated by the term “non-indanyl SDH inhibitor”. A non-indanyl SDH inhibitor suitable for use in the practice of the present invention may be selected from one in the group consisting of: fluopyram; bixafen; penflufen; sedaxane; isopyrazam; penthiopyrad; furametpyr; boscalid; fluxapyroxad; fenhexamid; carboxin; flutolanil; furametpyr; oxycarboxin; thifluzamide; fenfuram; N-[1-(2,4-dichlorophenyl)-1-methoxypropan-2-yl]-3-(difluoromethyl)-1-methyl-1H-pyrazole-4-carboxamide; N-[9-(dichloromethylen)-1,2,3,4-tetrahydro-1,4-methanonaphthalen-5-yl]-3-(difluoromethyl)-1-methyl-1H-pyrazol-4-carboxamide; N-[(1S,4R)-9-(dichloromethylen)-1,2,3,4-tetrahydro-1,4-methanonaphthalen-5-yl]-3-(difluoromethyl)-1-methyl-1H-pyrazol-4-carboxamide; N-[(1R,4S)-9-(dichloromethylen)-1,2,3,4-tetrahydro-1,4-methanonaphthalen-5-yl]-3-(difluoromethyl)-1-methyl-1H-pyrazol-4-carboxamide; 3-(difluoromethyl)-1-methyl-N-[2-(1,1,2,2-tetrafluoroethoxy)phenyl]-1H-pyrazol-4-carboxamide; 3-(difluoromethyl)-N-[4-fluoro-2-(1,1,2,3,3,3-hexafluoropropoxy)phenyl]-1-methyl-1H-pyrazol-4-carboxamide; 3-(difluoromethyl)-1-methyl-N-[2-(1,1,2,3,3,3-hexafluoropropoxy)phenyl]-1-methyl-1H-pyrazol-4-carboxamide; 3-(difluoromethyl)-1-methyl-N-[2-(3-Cl-1,1,2-trifluoroethoxy)phenyl]-1H-p-yrazol-4-carboxamide; N-[9-(dichloromethylene)-1,2,3,4-tetrahydro-1,4-methanonaphthalen-5-yl]-3-(difluoromethyl)-1-methyl-1H-pyrazole-4-carboxamide; N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide; and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.

In some embodiments, the non-indanyl SDHIs are selected from the group consisting of: fluopyram; bixafen; penflufen; sedaxane; isopyrazam; penthiopyrad; furametpyr; boscalid; fluxapyroxad; fenhexamid; carboxin; flutolanil; furametpyr; oxycarboxin; thifluzamide; and fenfuram. In some embodiments, the non-indanyl SDHI is selected from the group consisting of: fluopyram; bixafen; isopyrazam; penthiopyrad; boscalid; and fluxapyroxad. It can be preferred that the non-indanyl SDHI is bixafen.

The ratio of active SDHI compound to trialkyl phosphoric ester can be varied within a weight ratio (SDHI compound to phosphoric ester) of from about 1:0.2 to 1:5; preferably within a range of from about 1:0.6 to 1:2.

In addition to the phosphoric esters of the Formula I, crystallization inhibitors can be contained in the spray mixtures that can be used according to the invention. These crystallization inhibitors comprise amides of Formula III, R⁴CONR⁵R⁶, wherein: R⁴ comprises C₅-C₁₉ saturated alkyl, C₅-C₁₉ monounsaturated alkyl, or C₃-C₁₉ saturated or monounsaturated alkyl substituted with —OH; R⁵ comprises C₁-C₆ alkyl; and R⁶ comprises H or C₁-C₆ alkyl. In some embodiments R⁴ comprises C₈-C₁₉ alkyl, C₈-C₁₉ monounsaturated alkyl, or C₂-C₁₉ saturated alkyl substituted with —OH; R⁵ comprises C₁-C₆ alkyl; and R⁶ comprises C₁-C₆ alkyl. In other embodiments, R⁵ and R⁶ independently comprise C₁-C₂ alkyl. In one embodiment R⁵ and R⁶ are both methyl. Suitable amides of formula III include: N,N-dimethyl octanamide; N,N-dimethyl nonanamide; N,N-dimethyl decanamide; N,N-dimethyl 9-decenamide, optionally mixed with amides derived from C₁₂, C₁₄, or C₁₆ monounsaturated acids; N,N-dimethyl lactamide (2-hydroxy-N,N-dimethyl propanamide); or N,N-dimethyl 9-dodecenamide optionally mixed with amides derived from C₁₄ or C₁₆ monounsaturated acids. The unsaturated amides can be prepared according to methods described in PCT Patent Application Publication WO2012/061094. The amides can be used particularly in compositions wherein the SDHI comprises an amide of 4-aminoindane, such as 3-difluoromethyl-N-(7-fluoro-1,1,3-trimethyl-4-indanyl)-1-methyl-4-pyrazolecarboxamide.

Notably, when the SDHI is mixed with an additional fungicide, such as a triazole fungicide or a strobilurin fungicide in an emulsifiable concentrate and an amide of formula III, R⁴ comprises C₅-C₁₉ saturated alkyl, C₅-C₁₉ monounsaturated alkyl, C₂ alkyl substituted with —OH, or combinations thereof.

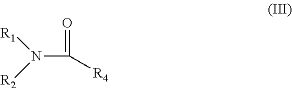

### Other Formulation Components

The trialkyl phosphoric acid ester (also referred to herein as “phosphoric ester”) can be incorporated into a single formulation comprising the agriculturally active compound (that is, a “ready to use” formulation). Alternatively, the phosphoric acid ester can be added to a concentrated formulation of the active compound—that is, a concentrated formulation of the active compound that is absent the phosphoric acid ester penetrant (“concentrated formulation”)—or to a mixture obtained from the concentrated formulation after dilution to form a spray liquor (a tank-mix). Dilution of the concentrated formulation with water can be preferred, but other diluents can be used.

It can be advantageous to incorporate the penetrants into a formulation together with the active agent. The compositions described herein may be in the form of ready to use emulsifiable concentrates, emulsions, or micro-emulsions that can be diluted with water to provide a final aqueous spray mixture comprising the active agent and the penetrant for application to the plant or plant part.

It can also be desirable to mix a formulated agrochemically active compound with the phosphoric ester penetrant in a tank mix. Tank mixing can be expedient, for example, when the active compound is available in a commercial formulation, or when it is otherwise expedient to use a formulation that does not include the phosphoric ester penetrant. Alternatively, a kit comprising a first container of the active agent with other optional formulation additives as described herein and a second container containing the phosphoric ester penetrant composition, wherein the contents of the containers are mixed such as in a tank mix prior to application to the plant or plant part.

Additives suitable for use in the formulations according to the invention are surface-active substances including surfactants and emulsifiers, organic diluents, acids, low-temperature stabilizers and crystallization inhibitors.

Suitable surface-active substances (surfactants, dispersants, protective colloids, emulsifiers, wetting agents) may be non-ionic, anionic, cationic or zwitterionic. The term “surfactant” is used herein generally for all such surface-active substances. A surfactant can be employed as the sole surfactant or in a mixture with various other surfactants.

Surfactants suitable for use in the practice of the present invention include: alkylnaphthalensulfonates; polynaphthalenesulfonates; alkylsulfonates; aryl sulfonates; alkylarylsulfonates; polycarboxylates; sulfosuccinates; alkylsulfosuccinates; lignosulfonates aryl sulfates, alkylarylsulfates; or alkyl sulfates. The surfactants can be used in acid form, or as sodium, calcium, potassium, triethylamine or triethanolamine salts, or as condensates with formaldehyde.

Useful surfactants also can include: reaction products of fatty acids; fatty acid esters; fatty alcohols; fatty amines; alkylphenols or alkylarylphenols with ethylene oxide and/or propylene oxide, and their sulfuric esters, phosphoric mono-esters and phosphoric di-esters, reaction products of ethylene oxide with propylene oxide, including polyethoxylated fatty alcohols, polyethoxylated alkyl phenols, polyethoxylated esters of sorbitol, or polyethoxylated polypropoxy block copolymers. Examples include reaction products of castor oil with ethylene oxide in a molar ratio of 1:20 to 1:60, reaction products of C₆-C₂₀ fatty alcohols with ethylene oxide in a molar ratio of 1:5 to 1:50, reaction products of fatty amines with ethylene oxide in a molar ratio of 1:2 to 1:20, reaction products of 1 mol of phenol with 2 to 3 mol of styrol and 10 to 50 of mol ethylene oxide, reaction products of 1 mol of phenol with 2 to 3 of vinyltoluene and 10 to 50 mols of ethylene oxide, reaction products of C₈-C₁₂ alkylphenols with ethylene oxide in a molar ratio of 1:5 to 1:30. Other surfactants include tetra-alkyl-ammonium halides, trialkyl-aryl-ammonium halides and alkyl glycosides.

Organic diluents suitable for use in the formulations described herein and resultant spray mixtures are selected from organic solvents that can either be polar or non-polar liquids. For the purposes of the present invention, the terms “diluent” and “solvent” can be used interchangeably herein, unless reasonably or specifically discouraged by the context. Generally, as used herein, a solvent can also be described as a diluent if it is present in an amount less than about 10 wt % of the composition but otherwise meets the criteria of a solvent as described herein. For example, in addition to water the following can be used herein to dissolve or dilute the concentrated formulation: aromatic solvents such as xylene, xyloles, alkylbenzole mixtures, and chlorobenzene, for example; paraffins (oil cuts); alcohols such as methanol, propanol, butanol, octanol, glycerol, benzyl alcohol, 1-methoxy-2-propanol, ethylene glycol phenyl ether, for example; esters such as ethyl acetate, isobutyl acetate, alkyl carbonates, alkyl esters of adipic acid such as dimethyl adipate and dibutyl adipate, alkyl esters of glutaric acid, alkyl esters of succinic acid, alkyl esters of lactic acid, and alkyl esters of C₅-C₂₄ fatty acids such as methyl oleate, for example; mineral oils or vegetable oils such as rapeseed oil, sunflower oil, soybean oil, castor oil, corn oil, peanut oil, for example, and their alkyl esters; ketones such as cyclohexanone, acetone, acetophenone, isophorone, methyl isobutyl ketone, and ethyl amyl ketone, for example; amides such as N,N-dimethylformamide, N-methylpyrrolidone, N-octyl-pyrrolidone, N-dodecyl-pyrrolidone, N-octyl-caprolactam, and N-dodecylcaprolactam, for example; sulfoxides and sulfones such as dimethylsulfoxide, and dimethyl-sulfone, for example; and mixtures thereof.

Preferred solvents include dialkyl adipates, especially dimethyl adipate. Notably, a combination of tris(C₆-C₁₀ alkyl phosphates) such as TEHP or tri-octyl phosphate and dialkyl adipates such as dimethyl adipate can improve leaf penetration. A particularly notable combination is TEHP and dimethyl adipate. The amides described above as crystallization inhibitors can also be particularly suitable solvents.

Use of the amides of Formula III as a second solvent in mixture with trialkyl phosphoric esters can be preferred in some embodiments. For example, mixtures of amides of Formula III with trialkyl phosphoric esters of Formula I can be preferred in formulations comprising Fluindapyr as the SDHI compound, or in formulations comprising Fluindapyr and prothioconazole. For example, useful amide solvents are: N,N-dimethyl octanamide; N,N-dimethyl nonanamide; N,N-dimethyl decanamide; N,N-dimethyl 9-decenamide, optionally mixed with amides derived from C₁₂, C₁₄, or C₁₆ monounsaturated acids; N,N-dimethyl lactamide (2-hydroxy-N,N-dimethyl propanamide); or N,N-dimethyl 9-dodecenamide optionally mixed with amides derived from C₁₄ or C₁₆ monounsaturated acids. Mixtures of amide solvents with TEHP can be particularly useful—particularly mixtures of TEHP and N,N-dimethyl decanamide. The amide/phosphoric ester solvent mixture can comprise the solvents in any effective ratio, but preferably the amide, when present as a solvent in mixture with the trialkyl phosphoric acid, is present in an amount of from about 40 to about 60 wt % of the solvent mixture. The amide can be present in the solvent mixture in an amount of from about 45 to about 55 wt % of the solvent mixture, or in an amount of from about 50 to about 55 wt % of the solvent mixture.

In other embodiments it can be advantageous to minimize or eliminate amide solvents. It has been found by the applicants that certain mixtures of emulsifiers can allow for the complete elimination of amide solvents in formulations of the present invention. One embodiment of the invention is a formulation of an SDHI wherein the formulated mixture does not include an amide solvent but includes an emulsifier mixture. The emulsifier mixture comprises or consists essentially of non-ionic surfactants such as: (i) alkoxylated alcohols, such as ethoxylated/propoxylated 2-ethylhexanol, and ethoxylated C11-C14 alcohols for example; (ii) alkoxylated castor oils such as ethoxylated castor oil for example; (iii) alkoxylated alcohol esters such as sorbitan trioleate ethoxylate for example; (iv) phosphate esters of tridecyl alcohol ethoxylate; or mixtures of any of these. The emulsifier mixture can optionally comprise anionic surfactants. In one embodiment the emulsifier mixture does not include benzene-containing emulsifiers.

The spray mixtures can comprise acids which can be inorganic acids and/or organic acids. Aliphatic and aromatic hydroxycarboxylic acids can be suitable for use herein; such as citric acid, salicylic acid and ascorbic acid, for example.

Low-temperature stabilizers (antifreeze agents) that are optionally present in the formulations include urea, glycerin and propylene glycol.

Additionally, the emulsifiable concentrates described herein can be diluted with solvent or diluent, preferably water, to provide spray mixtures that can be used according to the invention. The concentration of active compound in the spray mixtures of the invention can be varied within a certain range. In general, the concentration of active compound is from about 0.0003 to about 5 percent by weight, preferably from about 0.003 to about 3 percent by weight. However, the effectiveness of the active compound can vary within the disclosed ranged depending on other variables, including the plant species being treated and the amount of penetrant used. Therefore, the ratio of active compound to the penetrant can be a variant of the disclosed method.

The spray mixtures of the invention can be prepared by conventional methods. For example, a concentrate can be prepared by combining the components required in any desired sequence. Typically, the components are combined at temperatures between 10° C. and 30° C., mixing the batch until homogeneous, and, if appropriate, filtering the resulting mixture. To prepare aqueous spray mixtures that are ready for application, the concentrated formulation can be mixed with a quantity of water, with stirring and/or pumping if necessary to uniformly distribute the formulation in the water.

Conventional mixing apparatus and/or spray equipment suitable for the purpose can be employed for the preparation and application of the spray mixtures of the invention.

By using phosphoric esters of the Formula I in aqueous spray mixtures comprising SDHIs, the crystallization of active compound in the filters and outlet openings of the spray equipment is either prevented completely or inhibited in the concentrated, commercially available formulation and during application of the diluted aqueous spray mixtures.

### Other Active Ingredients

The composition of the invention may further comprise at least a fungicidal compound other than the SDHI to provide an expanded range of disease control and/or synergistic control. The compositions can optionally include at least a fungicidal component (“component [C]”) selected from fungicidal compounds belonging to one or more of the following groups of fungicidal compounds: i) azoles such as azaconazole, bitertanol, bromuconazole, cyproconazole, difenoconazole, epoxyconazole, fenbuconazole, fluquinconazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole, tricyclazole, triticonazole; ii) amino-derivatives such as aldimorph, dodine, dodemorph, fen-propimorph, fenpropidin, guazatine, iminoctadine, spiroxamine, tridemorph; iii) strobilurins such as azoxystrobin, dimoxystrobin, fluoxastrobin, kresoxim-methyl, metominostrobin, orysastrobin, picoxystrobin, pyraclostrobin, pyrametostrobin, pyraoxostrobin, trifloxystrobin; iv) specific anti-oidium compounds such as cyflufenamid, flutianil, metrafenone, proquinazid, pyriofenone, quinoxyfen; v) aniline-pyrimidines such as pyrimethanil, mepanipyrim, cyprodinil; vi) benzimidazoles and analogs such as benomyl, carbendazim, fuberidazole, thiabendazole, thiophanate-methyl; vii) dicarboximides such as iprodione, procymidone; viii) polyhalogenated compounds such as chlorothalonil, captan, captafol, folpet, dichlofluanid, tolylfluanid; ix) systemic acquired resistance (SAR) inductors such as acibenzolar, probenazole, isotianil, tiadinil; x) phenylpyrroles such as fenpiclonil, fludioxonil; xi) acylalanines such as benalaxyl, benalaxyl-M, furalaxyl, metalaxyl, metalaxyl-M; xii) anti-peronosporic compounds such as ametoctradin, amisulbrom, benthiavalicarb, cyazofamid, cymoxanil, dimethomorph, ethaboxam, famoxadone, fenamidone, flumetover, flumorph, fluopicolide, iprovalicarb, mandipropamid, valifenalate; xiii) dithiocarbamates such as maneb, mancozeb, propineb, zineb; xiv) arylamidines such as N-ethyl-N-methyl-N′-{4-[3-(4-chlorobenzyl)-1,2,4-thiadiazolyl-5-oxy]-2,5-xylyl}-formamidine; xv) phosphorous acid and derivatives such as fosetyl-aluminium, potassium phosphite, sodium phosphite, choline phosphite; xvi) fungicidal amides such as carpropamid, silthiofam, zoxamid, fluopicolide; and xviii) nitrogen heterocycles such as fenpyrazamine, fluazinam, pyribencarb, tebufloquin.

The fungicidal compounds among which to select the component [C] of the compositions are here indicated with their common international ISO name; their chemical structures and CAS and IUPAC chemical names are reported on the Alan Wood's Website (www.alanwood.net), Compendium of Pesticide Common Names; for most compounds, these features are also reported, together with chemical-physical data and biological features, in the “Pesticide Manual”, C. D. S. Tomlin, 15.sup.th Edition, 2009, British Crop Production Council Editor.

Notably, component [C] can be at least one selected from the group consisting of: an azole fungicide; a strobilurin; and a polyhalogenated fungicide, such as chlorothalonil.

Preferably, the azole fungicide may be a triazole selected from the group comprising azaconazole, bitertanol, bromuconazole, cyproconazole, diclobutrazol, difenoconazole, diniconazole, diniconazole-M, epoxiconazole, etaconazole, fenbuconazole, fluquinconazole, flutriafol, furconazole, furconazole-cis, hexaconazole, imibenconazole, ipconazole, metconazole, myclobutanil, paclobutrazol, penconazole, propiconazole, prothioconazole, quinconazole, simeconazole, tebuconazole, tetraconazole, triadimefon, triadimenol, triticonazole, uniconazole, uniconazole-P, voriconazole, and 1-(4-chlorophenyl)-2-(1H-1,2,4-triazol-1-yl)cycloheptanol. Other preferred azoles include flutriafol and tricyclazole. Notable azoles include prothioconazole, difenoconazole, and tricyclazole.

More preferably the triazole fungicide is selected from the group consisting of difenoconazole, flutriafol, epoxiconazole, prothioconazole and tebuconazole. Even more preferably, the triazole fungicide is selected from the group consisting of prothioconazole, difenoconazole and tebuconazole. A preferred triazole fungicide is prothioconazole.

In this context, it is noted that a preferred azole fungicide prothioconazole was classified as a triazole fungicide according to the widely accepted so-called FRAC-classification (classification by the Fungicide Resistance Action Committee), although FRAC has established a separate group of fungicides, “triazolinthiones”, referring to triazole fungicides with a sulfur group such as prothioconazole. For clarification, the definition of triazole fungicides according to this invention explicitly includes triazolinthiones such as prothioconazole.

Preferably the strobilurin is azoxystrobin, fluoxastrobin, kresoxim-methyl, picoxystrobin, pyraclostrobin, or trifloxystrobin; and more preferably azoxystrobin.

A preferred polyhalogenated fungicide comprises chlorothalonil.

Preferably, component [C] may comprise an azole fungicide, a strobilurin, or a polyhalogenated fungicide or a combination thereof. Preferably the composition may comprise, in addition to the SDHI, a combination of a strobilurin and an azole fungicide; preferably comprising azoxystrobin and an azole selected from the group consisting of difenoconazole and prothioconazole.

Optionally, it can be preferred that component [C] can include: ii) fenpropimorph, spiroxamine; iv) metrafenone, proquinazid; v) mepanipyrim, cyprodinil; vi) iprodione, procymidone; vii) carbendazim, thiophanate-methyl; x) fludioxonil; xi) benalaxyl, benalaxyl-M, metalaxyl-M; xii) benthiavalicarb, cyazofamid, cymoxanil, dimethomorph, mandipropamid, valifenalate.

The total amount of components (A) and, optionally, [C] to be applied to obtain the desired effect can vary according to different factors such as, for example, the compounds used, the crop to be preserved, the type of pathogen or insect, the degree of infection, the climatic conditions, the application method, the formulation used.

Overall doses of components (A) and, optionally, [C] ranging from 10 g to 5 kg per hectare of agricultural crop generally provide sufficient control of the pathogens.

The weight ratios of components (A) and [C] in the compositions of this invention can vary within a wide range, even depending on the parasites to be controlled and on the single component [C] used (or the plurality of components [C] used), and are usually comprised between 1:20 and 20:1. The ratio can also vary anywhere between about 10:1 to about 1:10, or from about 5:1 to about 1:5, or from about 3:1 to about 1:3. For a mixture of Fluindapyr and prothioconazole, for example, the ratio of Fluindapyr, component (A), to prothioconazole, component [C], can vary from 20:1 to 1:20, or more particularly from 3:1 to 1:3, 2:1 to 1:2, or can be 1:1.

The emulsifiable concentrate comprising the SDHI component and the component(s) [C] can be formulated separately and mixed in the preselected diluent (for example water) at the time of the treatment of the agricultural crops to be protected, or the SDHI and the component [C] can be combined before treatment into a single “ready to use” emulsifiable concentrate formulation as described herein.

The total concentration of components (A) and [C] in said compositions can vary within a wide range; it generally ranges from 1% to 99% by weight with respect to the total weight of the composition, preferably from 5% to 90% by weight with respect to the total weight of the composition.

If desired, other active ingredients compatible with the SDHI and additional fungicides can be added to the compositions, such as, for example, insecticidal compounds, phytoregulators, antibiotics, and/or mixtures thereof. By “compatible” it is meant that the other active ingredients are capable of forming a chemically and physically stable mixture with the SDHI composition and additional fungicides, without negatively affecting the effectiveness or use of the SDHI composition or its individual components.

The amounts of other active compounds or additives in the spray mixtures that can be used according to this invention can be varied. It can be preferred that other active compounds be used in amounts that are conventional for such compounds in aqueous spray mixtures.

In one embodiment a formulation of the present invention comprises or consists essentially of: (A) from about 5 to about 12 wt % of an SDHI as described herein; (B) from about 30 to about 70 wt % of a trialkyl phosphoric ester or mixture thereof, as described by Formula I; (C) from about 0 to about 15 wt % of a fungicide selected from the group consisting of: i) azoles; ii) amino-derivatives; iii) strobilurins; iv) specific anti-oidium compounds; v) aniline-pyrimidines; vi) benzimidazoles and analogs; vii) dicarboximides; viii) polyhalogenated compounds; ix) SAR inductors; xi) acylalanines; xii) anti-peronosporic compounds; xiii) dithiocarbamates; xiv) arylamidines; xv) phosphorous acid and derivatives; xvi) fungicidal amides; xvii) nitrogen heterocycles; and mixtures thereof; (D) from about 10 to about 20 wt % of an emulsifier mixture as described herein. In one embodiment the formulation comprises from about 15 to about 18 wt % of the emulsifier mixture.

All plants or any part of a plant can be treated in accordance with the invention. The term “plants” as used herein is to be understood as all plants and plant populations such as, for example, desired and undesired wild plants or crop plants (including naturally occurring crop plants). Crop plants can be plants that can be obtained by conventional breeding and optimization methods or by biotechnological and genetic engineering methods or by combinations of these methods, including transgenic plants and including plant cultivars which can or cannot be protected by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, as well as roots, tubers and rhizomes. The plant parts also include harvested material, and vegetative and generative propagation material, for example cuttings, tubers, rhizomes, offshoots and seeds.

Treatment of the plants and plant parts with the compositions according to the present invention is carried out by direct contact with the plant or plant part, or by action on the plant's environment, habitat or storage space using customary treatment methods. For example, treatment as described herein can be by dipping, spraying, evaporating, atomizing, broadcasting, spreading-on, injecting and, in the case of propagation material—particularly in the case of seeds—by applying a layer of a coating comprising the composition, optionally with additional layers.

Wild plant species and plant cultivars, or those obtained by conventional biological breeding methods, such as crossing or protoplast fusion, and parts thereof, may be treated. Also, transgenic plants and plant cultivars obtained by genetic engineering methods, if appropriate in combination with conventional methods (Genetically Modified Organisms), and parts thereof are treated. Plants of the plant cultivars that are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, biotypes or genotypes.

The transgenic plants or plant cultivars (obtained by genetic engineering) that may be treated according to the invention include all plants which, by the genetic modification, received genetic material which imparted particular advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defense of the plants against animal and microbial pests, such as against insects, mites, phytopathogenic fungi, bacteria and/or viruses, and increased tolerance of the plants to certain herbicidally active compounds. Examples of transgenic plants include the important crop plants, such as cereals (wheat, rice), maize, soybeans, potatoes, sugar beet, tomatoes, peas and other vegetable varieties, cotton, tobacco, oilseed rape and fruit plants (with the fruits apples, pears, citrus fruits and grapes), and emphasis is given to maize, soybeans, potatoes, cotton, tobacco and oilseed rape. Traits include the increased defense of the plants against insects, arachnids, nematodes and slugs and snails by toxins formed in the plants, particularly those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (“Bt plants”). Other traits are the increased defense of plants against fungi, bacteria and viruses by systemic acquired resistance (SAR), systemin, phytoalexins, elicitors and resistance genes and correspondingly expressed proteins and toxins. Traits also include the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” include maize varieties, cotton varieties, soybean varieties and potato varieties which are sold under the trade names YIELD GARD® (for example maize, cotton, soybeans), KnockOut® (for example maize), StarLink® (for example maize), Bollgard® (cotton), Nucotn® (cotton) and NewLeaf® (potato). Examples of herbicide-tolerant plants are maize varieties, cotton varieties and soybean varieties that are sold under the trade names Roundup Ready® (tolerance to glyphosate, for example maize, cotton, soybean). Liberty Link® (tolerance to phosphinotricin, for example oilseed rape), IMI® (tolerance to imidazolinones) and STS® (tolerance to sulfonylureas, for example maize). Herbicide-resistant plants (plants bred in a conventional manner for herbicide tolerance) include the varieties sold under the name Clearfield® (for example maize). The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

Crops that can be protected with the compositions according to this invention comprise cereals (wheat, barley, rye, oats, rice, maize, sorghum, etc.), fruit trees (apples, pears, plums, peaches, almonds, cherries, bananas, grapes, strawberries, raspberries, blackberries, etc.), citrus trees (oranges, lemons, mandarins, grapefruit, etc.), legumes (beans, peas, lentils, soybean, etc.), vegetables (spinach, lettuce, asparagus, cabbage, carrots, onions, tomatoes, potatoes, eggplants, peppers, etc.), cucurbitaceae (pumpkins, zucchini, cucumbers, melons, watermelons, etc.), oleaginous plants (sunflower, rape, peanut, castor, coconut, etc.), tobacco, coffee, tea, cocoa, sugar beet, sugar cane, and cotton.

The compositions of this invention comprising SDHI fungicides provide very high fungicidal activity, against numerous phytopathogenic fungi attacking important agricultural crops. The compositions provide a fungicidal activity that can be curative, preventive or eradicant, and generally have a very low or null phytotoxicity on the treated crops. It is therefore another object of this invention to use the fungicidal compositions described herein for the control of phytopathogenic fungi in agricultural crops.

Examples of phytopathogenic fungi that can be effectively treated and/or controlled with the compositions of this invention are those belonging to the groups of Basidiomycetes, Ascomycetes, Deuteromycetes or imperfect fungi, Oomycetes: Puccinia spp., Ustilago spp., Tilletia spp., Uromyces spp., Phakopsora spp., Rhizoctonia spp., Erysiphe spp., Sphaerotheca spp., Podosphaera spp., Uncinula spp., Helminthosporium spp., Rhynchosporium spp., Pyrenophora spp., Monilinia spp., Sclerotinia spp., Septoria spp. (Mycosphaerella spp.), Venturia spp., Botrytis spp., Alternaria spp., Fusarium spp., Cercospora spp., Cercosporella herpotrichoides, Colletotrichum spp., Pyricularia oryzae, Sclerotium spp., Phytophtora spp., Pythium spp., Plasmopara viticola, Peronospora spp., Pseudoperonospora cubensis, and Bremia lactucae.

In particular, the compositions of this invention have proven to be particularly effective in the control of Plasmopara viticola on vines, Phytophtora infestans and Botrytis Cinerea on tomatoes, Puccinia recondite, Erysiphae graminis, Helminthosporium teres, Septoria nodorum and Fusarium spp. on cereals, in the control of Phakopsora pachyrhizi on soybean, in the control of Uromyces appendiculatus on beans, in the control of Venturia inaequalis on apple-trees, in the control of Sphaerotheca fuliginea on cucumbers.

In addition, the compositions of this invention are also effective in the control of phytopathogenic bacteria and viruses, such as, for example, Xanthomonas spp., Pseudomonas spp., Erwinia amylovora, and the tobacco mosaic virus.

To protect the agricultural crops, the compositions of this invention can be applied to any part of the plant, or on the seeds before sowing, or on the soil in which the plant grows.

A further object of this invention relates to a method for the control of phytopathogenic fungi in agricultural crops, which comprises applying an effective dose of at least one fungicidal composition as described herein on one or more parts of the plant to be protected (for example, on seedlings, leaves, fruits, stems, branches, roots) and/or on the seeds of said plants before sowing, and/or on the soil in which the plant grows.

The following examples are provided for a better understanding of the invention, which should be considered as being illustrative and non-limiting of the same.

### Examples

### Materials Used

Active ingredients fluindapyr, prothioconazole, tebuconazole and difenoconazole were obtained as technical material prepared according to known procedures. The term “technical material” as used herein refers to the unformulated active ingredient as commercially produced. Technical material includes the named chemical compound and minor amounts of process impurities or byproducts. For example, technical material may be at least 94% pure (less than 6% impurities), and preferably at least 96% or at least 98% pure. Technical fluindapyr used herein was about 97% pure.

Solvents were obtained commercially as summarized below.

| Tradename | Common name | Commercial Source |
|---|---|---|
| | Tris(2-ethylhexyl)phosphate (TEHP) | |
| | Tri-isobutyl phosphate | |
| | Tri-octyl phosphate | |
| | Dimethyl adipate | |
| Amesolv ® CME | Methyl oleate | Ametech |
| Agnique ® AMD 3L | Dimethyl lactamide | BASF |
| Hallcomid ™ 1025 | N,N-Dimethyl 9-decenamide + other amides | Stepan |
| Genagen PA | N,N-Dimethyl nonanamide | Clariant |
| Rhodiasolv ® ADMA 810 | N,N-Dimethyl octamide + N,N-Dimethyl decanamide | Rhodia |
| Rhodiasolv ® ADMA | N,N-Dimethyl decanamide | Rhodia or BASF |
| 10 (or Agnique ® AMD 10) | | |
| | Propylene glycol | |
| | 2-Octanone | |
| Atlox Solval BDE-1 | Bicyclic Tetraether | Croda |
| Rhodiasolv ® Polarclean | methyl-5-(dimethylamino)-2-methyl-5-oxopentanoate | Rhodia |
| Glycerine | | Sigma- |
| | | Aldrich |
| 2-Octanone | | Sigma- |
| | | Aldrich |
| Amesolv CME | Methyl oleate | Ametech |

Emulsifiers, surfactants and other formulants were obtained commercially as summarized below.

| Tradename | General Description | Commercial Source |
|---|---|---|
| Rhodacal ® 60/BE | Linear Dodecylbenzene Sulfonate, Calcium Salt | Rhodia |
| | in 2-Ethylhexanol Solution (60%) | |
| Soprophor ® 4D384 | Polyarylphenyl Ether Sulfate, Ammonium Salt | Rhodia |
| Soprophor ® 3D33 LN | Tristyrylphenol Ethoxylate Phosphate Ester (acid form) | Rhodia |
| Soprophor ® BSU | Ethoxylated Tristyrylphenol | Rhodia |
| Soprophor ® TSP/724 | Ethopropoxylated Polyarylphenol | Rhodia |
| Soprophor ® 796/P | Ethopropoxylated Polyarylphenol | Rhodia |
| Soprophor ® TS/10 | Ethoxylated Tristyrylphenol | Rhodia |
| Emulsogen ® EL360 | Castor oil ethoxylate with 36 EO nonionic surfactant | Clariant |
| Toximul ® 8241 (CSO-30) | Castor oil ethoxylate nonionic surfactant | Stepan |
| Toximul ® 8242 (CSO-40) | Castor oil ethoxylate nonionic surfactant | Stepan |
| Toximul ® SEE-341 | Sorbital Monooleate Ethoxylate, POE-20 | Stepan |
| Antarox ® B848 | Butyl-capped EO/PO block copolymer | Rhodia |
| Antarox ® PLG/254 | EO/PO block copolymer | Rhodia |
| Ecosurf ™ EH-6 | Alcohol ethoxylate | Dow |
| Agnique ® CSO-35 | Ethoxylated Castor Oil, POE 35 | BASF |
| Dextrol ™ OC-180HS | Ethoxylated aliphatic alcohol phosphate ester, sodium | Ashland |
| | salt | |
| Atlas ™ G-5002L | Butyl Block Copolymer | Croda |
| Pluraflo ® L1060 | EO/PO block copolymer | BASF |
| Morwet D-425 | sodium salt of naphthalene sulfonate condensate | AkzoNobel |
| Sokalan ® K 30 P | Polyvinylpyrrolidone polymer | BASF |
| Dyne-Amic | methylated seed oil/nonionic surfactant blend | Helena |
| Nimbus ® | 42% paraffinic mineral oil, 58% inerts | Syngenta |

Compositions comprising an SDHI fungicide and in some examples, an azole fungicide were prepared, as summarized in the Tables below, wherein all amounts are reported as percent of the total formulation. Compositions denoted with a “C” prefix are comparative compositions not of this invention and are used as Comparative Examples to demonstrate the benefits of the compositions of this invention.

“Penetration” for the purposes of the present invention, is the uptake of the component in question by a plant. For the purposes of the present invention, penetration can be described as the uptake of a succinate dehydrogenase inhibitor (SDHI) as described herein. Penetration, or uptake, can be determined by any conventional means, but for the purposes of the present invention penetration is typically determined by extraction of the SDHI from a treated plant. For comparative purposes it is preferred that penetration is determined using the same methodology on the same or similar plant species.

### Rainfastness and Leaf Penetration

Pinto bean (Topaz) unifoliates or barley leaves were sprayed at 60 g ai/ha with 200 L/ha spray volume using a precision sprayer nozzle mounted on a ring stand above the leaf. Initial applied values were determined by immediately washing the active ingredient from leaves with acetonitrile. For rainfastness and penetration determination, the plants were held 24 hours in a growth chamber. After 24 hours, the leaves were washed with water to simulate rainfall to determine rainfastness, then washed with acetonitrile to remove active ingredient remaining on the surface of the leaf, followed by extraction of the leaf material to determine penetration. Increased penetration due to the phosphoric ester is indicated by a higher percentage of the active agent found in the leaf extraction compared to that found for spray compositions not comprising the phosphoric ester. Washes and extracts were quantified by LC/MS. Results are shown in Table 3.

### Phytotoxicity

Evidence of phytotoxicity was monitored on bean plants sprayed at a field use rate of 125 gai/ha or 625 ppm as described above. The percentage of foliage exhibiting phytotoxicity was determined and rated according to the following scoring system, wherein: 1=trace (<5%), 2=slight (5-10%), 3=moderate (11-25%), and 4=severe (>25%), and N=necrosis.

### Crystallization Stability

To determine stability, samples of the formulations were diluted in water at 1× field use rate spray solutions (125 g ai/ha or 625 ppm) and held for 0, 24 or 48 hours at ambient conditions. The aqueous spray mixtures were examined under a microscope at 400-630× magnification for evidence of crystal formation. The following rating system based on the number of crystals observed in the field of view of the microscope was used: Visual Crystallization Qualitative Scale (crystals per cell): 1=trace (several crystals in multiple fields of view), 2=slight (several crystals in one field of view), 3=moderate (many crystals in one field of view), and 4=extreme (numerous crystals in one field of view).

TABLE 1
Formulation Examples 1-5/C6

| Component (wt %) | | 1 | 2 | 3 | 4 | 5 | C6 |
|---|---|---|---|---|---|---|---|
| Fluindapyr | AI^{@} | 6.20 | 9.00 | 9.00 | 9.10 | 9.20 | 0 |
| Prothioconazole | AI | 7.80 | 11.40 | 11.30 | 11.30 | 0 | 0 |
| Tebuconazole | AI | 0 | 0 | 0 | 0 | 0 | 12.50 |
| TEHP | solvent | 59.20 | 0 | 0 | 0 | 0 | 0 |
| Tri-isobutyl phosphate | solvent | 0 | 61.80 | 62.00 | 61.80 | 73.20 | 67.90 |
| Dimethyl Adipate | solvent | 14.80 | 0 | 0 | 0 | 0 | 0 |
| Rhodacal ® 60/BE | emulsifier | 4.00 | 0 | 0 | 0 | 0 | 0 |
| Soprophor ® 4D384 | emulsifier | 0 | 11.60 | 0 | 11.60 | 11.20 | 12.90 |
| Soprophor ® 3D33 LN | emulsifier | 0 | 0 | 11.40 | 0 | 0 | 0 |
| Soprophor ® BSU | emulsifier | 8.00 | 0 | 0 | 0 | 0 | 0 |
| Emulsogen ® EL360 | surfactant | 0 | 0 | 0 | 6.20 | 0 | 0 |
| Toximul ® 8241 (CSO-30) | surfactant | 0 | 6.10 | 6.20 | 0 | 6.40 | 6.80 |
| Total | | 100 | 100 | 100 | 100 | 100 | 100 |

^{@}AI = active ingredient

TABLE 2
Formulation Examples C7-C9/10-11

| Component (wt %) | C7 | C8 | C9 | 10 | 11 |
|---|---|---|---|---|---|
| Fluindapyr | 6.5 | 42.7 | 42.7 | 6.5 | 6.22 |
| Prothioconazole | 0 | 0 | 0 | 0 | 7.78 |
| Tris(2-ethylhexyl) phosphate | 0 | 0 | 0 | 39 | 51.8 |
| Tri-octyl phosphate | 0 | 0 | 0 | 0 | 0 |
| Dimethyl Adipate | 0 | 0 | 0 | 39.5 | 22.2 |
| N,N-Dimethyl decanamide | 40.5 | 0 | 0 | 0 | 0 |
| methyl oleate | 38 | 0 | 0 | 0 | 0 |
| Nimbus (added in the spray | 0 | 0 | 0.5^{a} | 0 | 0 |
| tank) | | | | | |
| Rhodacal ® 60/BE | 5 | 0 | 0 | 5.0 | 5.0 |
| Sopraphor ® 796/P | 10 | 0 | 0 | 0 | 5.0 |
| Ecosurf EH-6 | 0 | 0 | 0 | 0 | 2.0 |
| Rhodasurf BC630 | 0 | 0 | 0 | 7.5 | 0 |
| Toximul 8320 | 0 | 0 | 0 | 2.5 | 0 |
| glycerine | 0 | 8 | 8 | 0 | 0 |
| Pluraflo ® L1060 | 0 | 2.5 | 2.5 | 0 | 0 |
| Mor wet D-425 | 0 | 1.5 | 1.5 | 0 | 0 |
| Sokalan K30P | 0 | 0.3 | 0.3 | 0 | 0 |
| water | 0 | 45 | 45 | 0 | 0 |
| Total | 100 | 100 | 100 | 100 | 100 |

^{a}concentration (wt %) in final spray tank solution

TABLE 3
Rainfastness

| | Leaf Wash | | | | | | | |
|---|---|---|---|---|---|---|---|---|
| | Recovered | | Recovered | | Leaf | | Total | |
| Formulation | (water) | | (acetonitrile) | | Extraction | | Recovered | |
| (applied rate of AI) | ug | wt %* | ug | wt %* | ug | wt %* | ug | wt %* |
| C7 (100 ppm) | 0.94 | 30 | 0.8 | 25 | 1.4 | 44 | 3.1 | 100 |
| C7 (300 ppm) | 2.42 | 26 | 1.3 | 15 | 5.4 | 59 | 9.2 | 100 |
| C8 (300 ppm) | 0.29 | 3 | 8.0 | 94 | 0.2 | 2 | 8.5 | 100 |
| C9 (300 ppm) | 1.57 | 15 | 4.5 | 42 | 4.7 | 43 | 10.8 | 100 |
| 10 (100 ppm) | 0.66 | 17 | 0.7 | 18 | 2.5 | 65 | 3.8 | 100 |
| 10 (300 ppm) | 2.31 | 22 | 2.1 | 20 | 5.8 | 56 | 10.5 | 98 |
| 11 (100 ppm) | 0.3 | 14 | 0.4 | 18 | 1.5 | 67 | 2.2 | 100 |
| 11 (300 ppm) | 0.8 | 14 | 1.2 | 22 | 3.5 | 64 | 5.5 | 100 |

*Based on the total active recovered in the washes and extraction

No phytotoxicity was observed at 300 ppm or 62.5 g ai/ha in these tests. A suspension concentrate (C8) had poor leaf uptake, which was somewhat improved by the addition of crop oil (C9) as a tank mix. Emulsion concentrates with trialkyl phosphates (formulations 10 and 11) showed improved leaf penetration compared to an emulsion concentrate comprising N,N-dimethyl decanamide and methyl oleate but no trialkyl phosphates (C7).

TABLE 4
Formulation Examples 12-13/C14-C16

| Component (wt %) | | 12 | 13 | C14 | C15 | C16 |
|---|---|---|---|---|---|---|
| Fluindapyr | active ingredient | 6.31 | 6.2 | 6.47 | 6.32 | 6.39 |
| Prothioconazole | active ingredient | 7.93 | 7.8 | 7.37 | 8.08 | 8.15 |
| TEHP | solvent | 35.2 | 59.2 | 0 | 0 | 0 |
| Dimethyl Adipate | solvent | 0 | 14.8 | 0 | 0 | 0 |
| Hallcomid 1025 | solvent | 35.1 | 0 | 46.4 | 70.03 | 34.5 |
| methyl oleate | solvent | 0 | 0 | 23.1 | 0 | 0 |
| 2-octanone | solvent | 0 | 0 | 0 | 0 | 34.8 |
| Rhodacal 60/BE | emulsifier | 3.1 | 4.0 | 4.93 | 4.66 | 4.83 |
| Soprophor 796/P | nonionic surfactant | 12.3 | 0 | 11.8 | 6.22 | 6.44 |
| Soprophor BSU | emulsifier | 0 | 8.0 | 0 | 0 | 0 |
| Ecosurf EH-6 | emulsifier | 0 | 0 | 0 | 4.66 | 4.83 |
| Total | | 100 | 100 | 100 | 100 | 100 |

TABLE 5
Crystal Formation/Phytotoxicity (Pinto Bean and Barley)

| | Crystal | | | | |
|---|---|---|---|---|---|
| | Formation | | | | |
| | in spray | Phytotoxicity | | | |
| | solution | Pinto Bean | | Barley | |
| | use rate | | | | |
| | | 625 ppm | 313 ppm | 625 ppm | 313 ppm |
| Formulation | 300 ppm | (125 g/ha) | (63 g/ha) | (125 g/ha) | (63 g/ha) |
| 1 | 0 | 0.3 | 0 | 0 | 0 |
| C7 | 0 | 1.0 | 0 | 0 | 0 |
| C8 | NA | 0 | 0 | 0 | 0 |
| C9 | NA | 0 | 0 | 0 | 0 |
| 12 | 0 | 1.8 | 0 | 0.1 | 0.1 |
| 13 | 0 | 0.3 | 0 | 0 | 0 |
| C14 | 0 | 0.8 | 0.3 | 0.3 | 0.1 |
| C15 | 0 | 3.3 | 1.0 | 0.7 | 0 |
| C16 | 0 | 1.3 | 0 | 0.1 | 0 |

TABLE 6
Rainfastness (Pinto Bean and Barley)

| | Leaf Wash | | | | | |
|---|---|---|---|---|---|---|
| | % Recovered | | % Recovered | | Leaf Extraction | |
| | in water wash | | in acetonitrile wash | | % Recovered | |
| | Pinto | | Pinto | | Pinto | |
| Formulation | Bean | Barley | Bean | Barley | Bean | Barley |
| 1 | 9 | — | 20 | — | 66 | — |
| C7 | 12 | 33 | 7 | 12 | 60 | 44 |
| C8 | 4 | 15 | 99 | 35 | 3 | 9 |
| C9 | 5 | 17 | 41 | 37 | 47 | 37 |
| 12 | 8 | 32 | 19 | 21 | 63 | 47 |
| 13 | 9 | 23 | 23 | 24 | 60 | 54 |
| C14 | 28 | 38 | 15 | 14 | 53 | 29 |
| C15 | 32 | 41 | 46 | 26 | 21 | 16 |
| C16 | 35 | 60 | 55 | 22 | 15 | 16 |

TABLE 7
Formulation Examples 17-23

| Component | | 17 | 18 | 19 | 20 | 21 | 22 | 23 |
|---|---|---|---|---|---|---|---|---|
| Fluindapyr | active ingredient | 9.2 | 9.1 | 9.2 | 9.2 | 9.0 | 9.27 | 9.2 |
| Prothioconazole | active ingredient | 11.2 | 11.2 | 11.6 | 11.4 | 11.2 | 11.4 | 11.5 |
| Tri-isobutyl phosphate | solvent | 62.1 | 51.7 | 52.1 | 52.0 | 52.0 | 30.5 | 65 |
| TEHP | solvent | 0 | 0 | 0 | 0 | 0 | 31.2 | 0 |
| Dimethyl Adipate | solvent | 0 | 0 | 9.9 | 0 | 0 | 0 | 0 |
| Methyl oleate | solvent | 0 | 10 | 0 | 0 | 0 | 0 | 0 |
| Dimethyl lactamide | solvent | 0 | 0 | 0 | 10.2 | 0 | 0 | 0 |
| Dimethyl decanamide | solvent | 0 | 0 | 0 | 0 | 10.0 | 0 | 0 |
| Soprophor ® 4D384 | emulsifier | 11.4 | 10.6 | 10.7 | 10.9 | 10.9 | 11.3 | 0 |
| Antarox ® B848 | emulsifier | 6.1 | 7.4 | 6.5 | 6.2 | 6.8 | 6.3 | 0 |
| Rhodacal 60/BE | emulsifier | 0 | 0 | 0 | 0 | 0 | 0 | 3.0 |
| Soprophor TS10 | emulsifier | 0 | 0 | 0 | 0 | 0 | 0 | 5.9 |
| Emulsogen EL360 | emulsifier | 0 | 0 | 0 | 0 | 0 | 0 | 5.8 |
| Total | | 100 | 100 | 100 | 100 | 100 | 100 | 100 |

Compositions of Table 7 exhibited no crystal growth on standing. As shown in Table 8, compositions 13 and 22 comprising tris(2-ethylhexyl) phosphate (TEHP) showed improved leaf penetration. Table 9 summarizes that these compositions exhibited little or no phytotoxicity on the bean shoots.

TABLE 8

| | Leaf Wash | | | | | | | |
|---|---|---|---|---|---|---|---|---|
| | Recovered | | Recovered | | | | | |
| | in water | | in acetonitrile | | Leaf | | Total | |
| | wash | | wash | | Extraction | | Recovered | |
| Formulation | ug | % | ug | % | ug | % | ug | % |
| C7 | 1.4 | 19 | 1.85 | 20 | 4.6 | 61 | 7.5 | 100 |
| C8 | 0.93 | 6 | 14.0 | 93 | 0.5 | 3 | 15.0 | 100 |
| 13 | 1.4 | 12 | 5.0 | 43 | 5.3 | 46 | 11.6 | 100 |
| 17 | 4.25 | 45 | 4.1 | 43 | 1.1 | 12 | 9.3 | 99 |
| 18 | 4.76 | 48 | 3.8 | 39 | 1.3 | 13 | 9.9 | 100 |
| 19 | 3.65 | 47 | 3.5 | 45 | 0.6 | 8 | 7.7 | 100 |
| 20 | 3.61 | 44 | 3.6 | 44 | 1.0 | 12 | 8.2 | 100 |
| 21 | 4.61 | 47 | 3.6 | 37 | 0.9 | 9 | 9.8 | 100 |
| 22 | 1.41 | 20 | 1.5 | 21 | 4.2 | 59 | 7.1 | 100 |
| 23 | 2.6 | 42 | 2.8 | 46 | 0.7 | 11 | 6.0 | 99 |

TABLE 9
Pinto Bean Phytotoxicity

use rate
625 ppm (125 g/ha)

| Formulation | Rep 1 | Rep 2 |
|---|---|---|
| C8 | 0 | 0 |
| 13 | 0 | 0 |
| 17 | 0.5N | 0.5N |
| 18 | 2N | 2N |
| 19 | 1N | 0 |
| 20 | 0 | 0.5N |
| 21 | 2N | 0.5N |
| 23 | 1N | 0 |

TABLE 10
Formulation Examples 24-26/C17-C18

| Component | C17 | 24 | 24B | 25 | C18 | 26 |
|---|---|---|---|---|---|---|
| Fluindapyr | 10.6 | 10.23 | 10 | 8.83 | 0 | 0 |
| Prothioconazole | 0 | 0 | 0 | 11.02 | 0 | 0 |
| Difenoconazole | 0 | 0 | 0 | 0 | 11.8 | 11.4 |
| N,N-Dimethyl decanamide | 59.4 | 0 | 38 | 0 | 0 | 48.4 |
| N,N-Dimethyl nonanamide | 0 | 37.70 | 0 | 32.87 | 0 | 0 |
| 2-Octanone | 0 | 0 | 0 | 0 | 51.4 | 0 |
| Tris(2-ethylhexyl) phosphate | 0 | 37.77 | 0 | 32.64 | 0 | 11.9 |
| 2-methylphenyl diphenyl phosphate | 0 | 0 | 38 | 0 | 0 | 0 |
| Methyl oleate | 0 | 0 | 0 | 0 | 0 | 0 |
| Propylene glycol | 10 | 0 | 0 | 0 | 10.8 | 0 |
| Soprophor ® TSP/724 | 10 | 0 | 0 | 0 | 0 | 0 |
| Rhodacal ® 60/BE | 0 | 4.01 | 4 | 3.96 | 0 | 0 |
| Sopraphor ® 796/P | 0 | 5.08 | 5 | 5.15 | 0 | 0 |
| Soprophor ® BSU | 0 | 4.95 | 5 | 5.09 | 0 | 9.89 |
| Antarox ® PLG/254 | 10 | 0 | 0 | 0 | 0 | 5.93 |
| Toximul ® 8242 (CSO-40) | 0 | 0 | 0 | 0 | 0 | 3.06 |
| Toximul ® SEE-341 | 0 | 0 | 0 | 0 | 10.92 | 0 |
| Atlas ™ G-5002L | 0 | 0 | 0 | 0 | 5.23 | 0 |
| Total | 100 | 100 | 100 | 100 | 100 | 100 |

TABLE 11
Formulation Examples 27-34

| Component | 27 | 28 | 29 | 30 | 31 | 32 | 33 | 34 |
|---|---|---|---|---|---|---|---|---|
| Fluindapyr | 9.68 | 10.31 | 10.6 | 10 | 9.81 | 10.2 | 10.13 | 10.25 |
| N,N-Dimethyl decanamide | 0 | 0 | 38 | 0 | 39 | 34.2 | 0 | 23.56 |
| Tris(2-ethylhexyl) phosphate | 38.45 | 34.39 | 38 | 37.43 | 0 | 0 | 0 | 22.84 |
| Tri-isobutyl phosphate | 36.9 | 34.66 | 0 | 37.43 | 36.74 | 35.13 | 69.43 | 22.84 |
| Soprophor ® 4D384 | 9.54 | 4.13 | 0 | 0 | 0 | 3.94 | 4.01 | 4.33 |
| Antarax ® B848 | 5.12 | 6.24 | 0 | 0 | 0 | 0 | 6.48 | 0 |
| Soprophor ® BSU | 0 | 0 | 5 | 5.4 | 4.83 | 5.85 | 0 | 6.03 |
| Rhodacal ® 60/BE | 0 | 2.91 | 4 | 4.42 | 4.38 | 2.9 | 3.09 | 2.89 |
| Sopraphor ® 796/P | 0 | 4.92 | 5 | 5.04 | 4.98 | 4.87 | 5.10 | 4.90% |
| Ecosurf ™ EH-6 | 0 | 2.17 | 0 | 0 | 0 | 2.64 | 1.49 | 2.11 |
| Total | 100 | 100 | 100 | 100 | 100 | 100 | 100 | 100 |

Tables 12, 13 and 15 summarize compositions comprising fluindapyr and prothioconazole.

TABLE 12
Formulation Examples C19-21/35-37

| Component | C19 | C20 | C21 | 35 | 36 | 37 |
|---|---|---|---|---|---|---|
| Fluindapyr | 6.5 | 6.6 | 6.4 | 6.35 | 8.91 | 8.87 |
| Prothioconazole | 8.1 | 8.3 | 8.2 | 7.96 | 11.06 | 11.26 |
| Hallcomid 1025 | 46.8 | 34.5 | 69.9 | 34.89 | 32.66 | 0 |
| Methyl oleate | 23 | 0 | 0 | 0 | 0 | 0 |
| 2-octanone | 0 | 34.5 | 0 | 0 | 0 | 0 |
| Tris(2-ethylhexyl) phosphate | 0 | 0 | 0 | 34.96 | 32.61 | 30 |
| Tri-isobutyl phosphate | 0 | 0 | 0 | 0 | 0 | 35 |
| Ecosurf ™ EH-6 | 0 | 4.8 | 3.1 | 0 | 0 | 0 |
| Soprophor ® BSU | 0 | 0 | 0 | 0 | 6.08 | 0 |
| Rhodacal ® 60/BE | 4.7 | 4.8 | 6.2 | 3.15 | 3.11 | 2 |
| Sopraphor ® 796/P | 11 | 6.4 | 6.2 | 12.27 | 5.14 | 5 |
| Soprophor ® 4D384 | 0 | 0 | 0 | 0 | 0 | 4 |
| Antarox ® B848 | 0 | 0 | 0 | 0 | 0 | 4 |
| Total | 100 | 100 | 100 | 100 | 100 | 100 |

TABLE 13
Formulation Examples 38-47

| Component | 38 | 39 | 40 | 41 | 42 | 43 | 44 | 45 | 46 | 47 |
|---|---|---|---|---|---|---|---|---|---|---|
| Fluindapyr | 6.2 | 9 | 9 | 9 | 9.1 | 9.2 | 9.2 | 9.2 | 9.2 | 9.3 |
| Prothioconazole | 7.8 | 11.2 | 11.2 | 11.2 | 11.2 | 11.6 | 11.4 | 11.4 | 11.2 | 11.4 |
| N,N-dimethyl decanamide | 0 | 0 | 0 | 0 | 0 | 0 | 0 | 10.0 | 0 | 0 |
| Methyl oleate | 0 | 0 | 0 | 0 | 10.0 | 0 | 0 | 0 | 0 | 0 |
| Tris(2-ethylhexyl) phosphate | 59.2 | 0 | 0 | 0 | 0 | 0 | 0 | 0 | 0 | 31.2 |
| Tri-isobutyl phosphate | 0 | 65.3 | 64.9 | 62.4 | 51.7 | 52.1 | 52.0 | 52.0 | 62.1 | 30.5 |
| Dimethyl Adipate | 14.8 | 0 | 0 | 0 | 0 | 9.9 | 0 | 0 | 0 | 0 |
| Dimethyl lactamide | 0 | 0 | 0 | 0 | 0 | 0 | 10.2 | 0 | 0 | 0 |
| Rhodacal ® 60/BE | 4.0 | 2.9 | 5.8 | 0 | 0 | 0 | 0 | 0 | 0 | 0 |
| Soprophor ® 4D384 | 0 | 0 | 0 | 11.3 | 10.6 | 10.7 | 10.9 | 10.9 | 11.4 | 11.3 |
| Antarox ® B848 | 0 | 0 | 0 | 0 | 7.4 | 6.5 | 6.2 | 6.5 | 6.1 | 6.3 |
| Soprophor ® BSU | 8.0 | 0 | 0 | 0 | 0 | 0 | 0 | 0 | 0 | 0 |
| Soprophor ® TS10 | 0 | 5.8 | 3.9 | 0 | 0 | 0 | 0 | 0 | 0 | 0 |
| Emulsogen ® EL360 | 0 | 5.8 | 0 | 0 | 0 | 0 | 0 | 0 | 0 | 0 |
| Agnique ® CSO-35 | 0 | 0 | 4.8 | 0 | 0 | 0 | 0 | 0 | 0 | 0 |
| Toximul ® 8241 (CSO-30) | 0 | 0 | 0 | 6.1 | 0 | 0 | 0 | 0 | 0 | 0 |
| Total | 100 | 100 | 100 | 100 | 100 | 100 | 100 | 100 | 100 | 100 |

Table 14 summarizes leaf penetration testing for many formulations listed in Tables 12 and 13. The data show that penetration is enhanced for formulations comprising TEHP, and especially for formulations comprising both TEHP and TIBP.

TABLE 14

| | Leaf Wash | | | |
|---|---|---|---|---|
| | % Recovered | % Recovered | % Recovered | |
| Formulation | in water | in acetonitrile | in Leaf | Total |
| (625 ppm) | wash | wash | Extraction | Recovered |
| C17 | 41 | 44 | 15 | 100 |
| 24B | 51 | 35 | 14 | 100 |
| 27 | 7 | 18 | 75 | 100 |
| 28 | 28 | 18 | 53 | 99 |
| 29 | 44 | 35 | 21 | 100 |
| 30 | 8 | 26 | 66 | 100 |
| 31 | 36 | 53 | 11 | 100 |
| 33 | 58 | 31 | 11 | 100 |
| 35 | 5 | 51 | 45 | 100 |
| 36 | 11 | 28 | 61 | 100 |
| 37 | 9 | 55 | 42 | 100 |
| 38 | 11 | 25 | 65 | 100 |
| 39 | 37 | 44 | 19 | 100 |
| 42 | 48 | 39 | 13 | 100 |
| 43 | 47 | 45 | 8 | 100 |
| 44 | 44 | 44 | 12 | 100 |
| 45 | 47 | 37 | 9 | 100 |
| 46 | 45 | 43 | 12 | 99 |
| 47 | 20 | 21 | 59 | 100 |

TABLE 15

| | Example | | | | | | | | | |
|---|---|---|---|---|---|---|---|---|---|---|
| Component | 48 | C22 | C23 | 49 | C24 | C25 | 50 | 51 | C26 | 52 |
| Fluindapyr | 8.76 | 8.87 | 8.79 | 8.65 | 8.41 | 8.31 | 8.84 | 8.45 | 8.98 | 8.44 |
| Prothioconazole | 10.85 | 11.03 | 11.50 | 11.05 | 10.36 | 10.38 | 11.14 | 10.53 | 11.22 | 10.67 |
| N,N-Dimethyl | 0 | 34.09 | 0 | 0 | 32.93 | 0 | 0 | 0 | 0 | 0 |
| decanamide | | | | | | | | | | |
| Hallcomid ® 1025 | 0 | 0 | 33.71 | 35.47 | 0 | 32.34 | 0 | 33.35 | 0 | 0 |
| TEHP | 29.70 | 0 | 0 | 34.30 | 0 | 0 | 29.88 | 33.11 | 0 | 15.06 |
| 2-Octanone | 34.55 | 35.38 | 35.08 | 0 | 33.16 | 32.87 | 34.66 | 0 | 65 | 15.2 |
| Propylene glycol | 0 | 0 | 0 | 0 | 0 | 0 | 0 | 0 | 0 | 23.11 |
| Rhodiasolv ® Polarclean | 0 | 0 | 0 | 0 | 0 | 0 | 0 | 0 | 0 | 11.2 |
| Antarox ® PLG/254 | 0 | 3.27 | 3.38 | 3.11 | 3.1 | 2.98 | 3.8 | 2.9 | 3.1 | 0 |
| Dextrol ™ OC-180HS | 8.99 | 0 | 0 | 0 | 0 | 5.86 | 5.31 | 0 | 5.7 | 0 |
| Soprophor ® BSU | 0 | 6.93 | 7.1 | 6.99 | 11.63 | 6.84 | 5.94 | 11.24 | 6 | 0 |
| Antarox ® B848 | 6.73 | 0 | 0 | 0 | 0 | 0 | 0 | 0 | 0 | 0 |
| Toximul ® SEE 341 | 0 | 0 | 0 | 0 | 0 | 0 | 0 | 0 | 0 | 10.12 |
| Atlas ™ G-5002L | 0 | 0 | 0 | 0 | 0 | 0 | 0 | 0 | 0 | 5.79 |
| Total | 100 | 100 | 100 | 100 | 100 | 100 | 100 | 100 | 100 | 100 |

Table 16 summarizes formulations comprising fluindapyr, azoxystrobin and/or difenoconazole.

TABLE 16

| Example | 53 | 54 | 55 | 56 | 57 | 58 | 59 | 60 | 61 | 62 | 63 | 64 | 65 |
|---|---|---|---|---|---|---|---|---|---|---|---|---|---|
| Fluindapyr | 7.5 | 8.5 | 7.6 | 8.5 | 8.3 | 8.3 | 8.3 | 8.2 | 8.3 | 7.4 | 7.4 | 7.5 | 7.6 |
| Azoxystrobin | 7.8 | 8.4 | 7.8 | 8.5 | 8.4 | 0 | 0 | 0 | 0 | 7.6 | 7.5 | 7.5 | 7.6 |
| Difenoconazole | 9.0 | 0 | 0 | 0 | 0 | 10.2 | 10.2 | 10.1 | 10.1 | 9.3 | 9.4 | 9.4 | 9.5 |
| AMD10¹ | 0 | 0 | 0 | 0 | 16.8 | 0 | 0 | 0 | 16.0 | 0 | 0 | 0 | 14.9 |
| 1025² | 0 | 0 | 0 | 16.5 | 0 | 0 | 0 | 16.2 | 0 | 0 | 0 | 14.7 | 0 |
| TEHP | 0 | 0 | 15.0 | 0 | 0 | 0 | 16.1 | 0 | 0 | 0 | 14.8 | 0 | 0 |
| TIBP | 0 | 16.4 | 0 | 0 | 0 | 16.2 | 0 | 0 | 0 | 15.1 | 0 | 0 | 0 |
| AMD 3L³ | 23.5 | 26.2 | 25.7 | 25.8 | 25.9 | 25.5 | 25.6 | 25.0 | 25.6 | 23.4 | 23.3 | 23.7 | 23.3 |
| ⁴Polarclean | 11.4 | 12.7 | 17.6 | 12.7 | 12.7 | 12.6 | 12.6 | 13.0 | 12.9 | 12.2 | 12.4 | 11.5 | 12.1 |
| ⁵BDE-1 | 10.0 | 11.0 | 10.2 | 10.8 | 11.2 | 10.7 | 10.9 | 11.2 | 10.7 | 9.8 | 10.2 | 10.5 | 9.9 |
| ⁶SEE 341 | 10.14 | 10.91 | 10.38 | 10.84 | 10.81 | 10.58 | 10.57 | 10.54 | 10.61 | 9.88 | 9.72 | 9.83 | 9.87 |
| Atlas G-5002L | 5.66 | 5.92 | 5.69 | 6.50 | 5.91 | 5.90 | 5.88 | 5.75 | 5.83 | 5.33 | 5.37 | 5.43 | 5.45 |
| | 100 | 100 | 100 | 100 | 100 | 100 | 100 | 100 | 100 | 100 | 100 | 100 | 100 |

¹Agnique ® AMD10;
²Hallcomid ® 1025;
³Agnique ® AMD 3L;
⁴Rhodiasolv ® Polarclean;
⁵Atlox Solval BDE-1;
⁶Toximul ® SEE 341

As demonstrated by the data summarized in Table 17, formulations comprising TEHP (55, 59, and 63) demonstrated greater penetration of fluindapyr into to the leaf compared to formulations without TEHP. Comparison of Examples 55, 59, and 63 to the commercial SC formulation Quadris Top® shows that TEHP also improves leaf penetration of azoxystrobin and defenoconazole.

TABLE 17

| | Penetration | | |
|---|---|---|---|
| | % of applied active found in leaf | | |
| Formulation | fluindapyr | azoxystrobin | difenoconazole |
| 54 | 7 | 5 | NA |
| 55 | 42 | 17 | NA |
| 56 | 10 | 10 | NA |
| 57 | 10 | 9 | NA |
| 58 | 8 | NA | 10 |
| 59 | 37 | NA | 39 |
| 60 | 13 | NA | 21 |
| 61 | 14 | NA | 18 |
| 62 | 6 | 3 | 6 |
| 63 | 41 | 14 | 39 |
| 64 | 10 | 8 | 12 |
| 65 | 13 | 10 | 13 |
| C7 | 48 | NA | NA |
| Quadris Top ® SC | NA | 2 | 5 |
| (18.2% azoxystrobin + | | | |
| 11.4% difenoconazole) | | | |

Tris(2-ethylhexyl) phosphate (TEHP) was added to a suspension concentrate in the spray tank to determine the effect of a trialkyl phosphate as a tank mix in improving leaf penetration.

TABLE 18
Formulation Examples

| | | | C27 | 66 |
|---|---|---|---|---|
| | | | Description | |
| | | | C8 + | C8 + |
| Component | 24 | C8 | Oil* | TEHP* |
| Fluindapyr | 10.23 | 42.7 | 42.7 | 42.7 |
| Tris(2-ethylhexyl) phosphate | 37.77 | 0 | 0 | 0.448* |
| N,N-Dimethyl nonanamide | 37.70 | 0 | 0 | 0 |
| Rhodacal ® 60/BE | 4.01 | 0 | 0 | 0 |
| Sopraphor ® 796/P | 5.08 | 0 | 0 | 0 |
| Sopraphor ® BSU | 4.95 | 0 | 0 | 0 |
| glycerine | 0 | 8 | 8 | 8 |
| Pluraflo ® L1060 | 0 | 2.5 | 2.5 | 2.5 |
| Morwet D-425 | 0 | 1.5 | 1.5 | 1.5 |
| Sokalan ® K30P | 0 | 0.3 | 0.3 | 0.3 |
| water | 0 | 45 | 45 | 45 |
| Dyne-Amic* | 0 | 0 | 0.625* | 0 |
| % TEHP in final spray | 0.00112 | 0 | 0 | 0.00112 |
| solution | | | | |
| Ratio of Fluindapyr to | 1:3.6 | | | 1:3.5 |
| TEHP in final spray | | | | |
| solution | | | | |

*added as a tank mix formulant

The formulations were sprayed at 312 ppm of the formulation in leaf penetration tests. The results are summarized in Table 19. Superior leaf penetration was observed when an emulsifiable concentrate comprising TEHP was sprayed on the leaf (Formulation 24). The suspension concentrate (C8) showed poor leaf penetration. Addition of an oil/surfactant blend as a tank mix with suspension concentrate C8 provided improved leaf penetration (C27), but still not as good as shown by the EC comprising TEHP (24). Adding TEHP as a spray tank formulant (Formulation 66) to the SC formulation provided leaf penetration comparable to that of the EC formulation 24. Pluraflo® L1060 was in the base SC formulation, but did not provide good leaf penetration. Thus, the improved leaf penetration exhibited by Formulation 54 is a result of the TEHP.

TABLE 19

| | % Total | % Total | | Total Leaf |
|---|---|---|---|---|
| | Leaf wash | Leaf Wash | % Total | wash + |
| Formulation | H₂0 | Acetonitrile | In the Leaf | extract |
| C8 | 4 | 91 | 4 | 99 |
| C27 | 7 | 48 | 45 | 100 |
| 24 | 13 | 18 | 69 | 100 |
| 66 | 20 | 15 | 65 | 100 |

Additional examples of using TEHP at different ratios to the active ingredient as a tank mix formulant with a suspension concentrate are summarized in Tables 20 and 21.

TABLE 20

| | 67 | 68 | 69 | 70 |
|---|---|---|---|---|
| | Description | | | |
| | C8 + 0.0012% | C8 + 0.0021% | C8 + 0.003% | C8 + 0.0076% |
| Tank Mix Example | TEHP* | TEHP* | TEHP* | TEHP* |
| Ratio of Fluindapyr | 1:4 | 1:7 | 1:10 | 1:25 |
| to TEHP | | | | |
| in final spray solution | | | | |

TABLE 21

| | % Total | % Total | | Total Leaf |
|---|---|---|---|---|
| | Leaf wash | Leaf Wash | % Total | wash + |
| Formulation | H₂0 | Acetonitrile | In the Leaf | extract |
| C8 | 3 | 90 | 7 | 100 |
| 24 | 12 | 23 | 66 | 101 |
| 67 | 6 | 40 | 54 | 100 |
| 68 | 4 | 23 | 73 | 100 |
| 69 | 2 | 32 | 66 | 100 |
| 70 | 2 | 32 | 66 | 100 |

### Disease Control Tests

Greenhouse and field trials were conducted on cereal pathogens affecting winter wheat and/or barley, including:

Wheat Septoria Leaf Blotch, caused by Mycosphaerella graminicola (Synonym: Septoria tritici, Correct taxonomic name: Zymoseptoria tritici).

Wheat Stagonospora Blotch, caused by Parastagonospora nodorum (Phaeosphaeria nodorum).

Wheat Tan Spot, caused by Drechslera tritici-repentis (Pyrenophora tritici-repentis).

Wheat Leaf Rust, caused by Puccinia rust fungus. Puccinia triticina causes ‘black rust’, P. recondita causes ‘brown rust’ and P. striiformis causes ‘Yellow rust’. Barley Diseases include Rhyncosporium (Rhynchosporium secalis), Net Blotch (Pyrenophora teres), Ramularia (Ramularia collo-cygni), Brown Rust (Puccinia hordei) and Yellow Rust (Puccinia striiformis f. sp. Hordei).

In the Tables, curative tests include applying the formulation n days after inoculation, and preventive tests include applying the formulation just prior to inoculation.

TABLE 22

| | Wheat Leaf Rust | | | | |
|---|---|---|---|---|---|
| | | % Disease Control | | | % Disease in |
| | Rate | Formulation | | | Inoculated |
| | (g ai/ha) | 35 | 36 | 37 | Controls^{a} |
| 2-day Curative | 5 | 69 | — | — | 25 |
| | 10 | 68 | — | — | — |
| | 50 | 99 | — | — | — |
| 4-day Curative | 5 | 78 | 46 | 63 | 19 |
| | 10 | 84 | 71 | 80 | — |
| | 150 | 98 | 98 | 98 | — |
| 5-day Curative | 5 | 13 | — | — | 25 |
| | 10 | 43 | — | — | — |
| | 50 | 83 | — | — | — |

^{a}Percentage (area %) of diseased area on leaf of an inoculated control.

TABLE 23

| | | | | | % Disease in |
|---|---|---|---|---|---|
| | Rate | | | | Inoculated |
| | (g ai/ha) | % Disease Control | | | Controls |
| | | Formulation | | | |
| | | C17 | 28 | | |
| 2-day Curative | 10 | 14 | 10 | | 16 |
| | 100 | 51 | 43 | | |
| | 300 | 67 | 66 | | |
| | | Formulation | | | |
| | | 35 | 36 | 37 | |
| 2-day Curative | 1 | 13 | 23 | 11 | 7 |
| | 10 | 67 | 49 | 52 | |
| | 150 | 42 | 41 | 71 | |
| | 1 | 65 | 38 | 52 | 31 |
| | 10 | 75 | 71 | 75 | |
| | 150 | 84 | 75 | 66 | |
| 5-day Curative | 1 | 10 | — | — | 41 |
| | 10 | 2 | — | — | |
| | 150 | 32 | — | — | |
| 0-day Preventive | 1 | 20 | — | — | 16 |
| | 10 | 60 | — | — | |
| | 150 | 95 | — | — | |
| | | Formulation | | | |
| | | C7 | | | |
| 0-day Preventive | 10 | 28 | | | 25 |
| | 100 | 60 | | | |
| | 300 | 88 | | | |

Field trials in Europe on winter wheat showed that the combination of long-chain amide and tris(2-ethylhexyl) phosphate (as in Formulation 35) produced a significantly higher and more robust level of efficacy on key diseases such as Septoria Leaf Blotch (Zymoseptoria tritici) than comparative compositions that did not include tris(2-ethylhexyl) phosphate.

Seven field tests were conducted to compare a formulation of this invention to formulations without a phosphate. The EC compositions each comprised fluindapyr at about 60 g/L and prothioconazole at about 75 g/L. All trials were conducted to provide an equal field rate of prothioconazole of 150 g/ha. The standard was Aviator Xpro®, an EC comprising a combination of 75 g/L bixafen and 150 g/l prothioconazole. Yellow Rust (Puccinia striiformis), Brown Rust (Puccinia triticina) and Powdery Mildew (Blumeria graminis f sp. Tritici) were 100% controlled by all treatments. Table 20 summarizes the results of field test plots wherein the control of Septoria Leaf Blotch provided by the test formulations was compared to the commercial standard. The number of plots whose performance fell within each of the categories is reported in Table 20. The results indicate that Formulation 35 performed better than the other test formulations and generally equal or superior to the standard.

TABLE 24

| Application | | Significantly | Numerically | | Numerically | Significantly |
|---|---|---|---|---|---|---|
| timing | Formulation | weaker¹ | weaker | Equal | stronger | stronger¹ |
| Leaf 1 | C19 | 1 | 5 | 0 | 1 | 0 |
| (Flag Leaf) | C20 | 0 | 4 | 2 | 1 | 0 |
| | C21 | 1 | 4 | 1 | 1 | 0 |
| | C17 + | 0 | 3 | 1 | 3 | 0 |
| | prothioconazole | | | | | |
| | tank mix | 0 | 1 | 1 | 5 | 0 |
| | 35 | | | | | |
| Leaf 2 | C19 | 0 | 4 | 1 | 2 | 0 |
| | C20 | 0 | 5 | 1 | 1 | 0 |
| | C21 | 0 | 5 | 2 | 0 | 0 |
| | C17 + | 0 | 7 | 0 | 0 | 0 |
| | prothioconazole | | | | | |
| | tank mix | 0 | 2 | 2 | 3 | 0 |
| | 35 | | | | | |

¹p = 0.05, Student-Newman-Keuls

The same formulations were also tested in winter barley. In the barley field trials, all test formulations provided control of Ramularia (Ramularia collo-cygni) equivalent to the standard. Formulations 35 and C21 indicated better efficacy compared to the other test compositions against Rhyncosporium (Rhynchosporium secalis), comparable to the standard. Formulation 35 performed better than formulation C21, and the other formulations against Barley Net Blotch (Pyrenophora teres), comparable to the standard.

1. A composition for the protection of agricultural crops comprising:
(A) a succinate dehydrogenase inhibitor (SDHI); and
(B) a phosphoric ester of the formula (R¹O)(R²O)(R³O)P═O, wherein:
(i) R¹ represents straight-chain or branched alkyl having 4 to 12 carbon atoms, or phenyl optionally substituted with 1-3 C₁-C₄ alkyl groups;
(ii) R² represents straight-chain or branched alkyl having 2 to 8 carbon atoms, or phenyl optionally substituted with 1-3 C₁-C₄ alkyl groups; and
(iii) R³ represents straight-chain or branched alkyl having 2 to 8 carbon atoms, or phenyl optionally substituted with 1-3 C₁-C₄ alkyl groups.

2. The composition of claim 1 wherein the SDHI comprises an amide of 4-aminoindane.

3. The composition of any one of the preceding claims wherein the SDHI comprises 3-difluoromethyl-N-(7-fluoro-1,1,3-trimethyl-4-indanyl)-1-methyl-4-pyrazolecarboxamide (fluindapyr).

4. The composition of claim 1 wherein the SDHI is a non-indanyl SDHI.

5. The composition of claim 4 wherein the SDHI is bixafen.

6. The composition of any one of the preceding claims wherein:
(i) R¹ represents n-butyl; iso-butyl; sec-butyl; tert-butyl; n-pentyl; n-hexyl; 2-ethyl-hexyl; n-heptyl; n-octyl; iso-octyl; n-nonyl; iso-nonyl; n-decyl; n-dodecyl; iso-dodecyl; phenyl; 3-methyl phenyl; 2,4-dimethyl phenyl; isopropyl phenyl; or t-butyl phenyl;
(ii) R² represents n-butyl; iso-butyl; sec-butyl; tert-butyl; n-pentyl; n-hexyl; 2-ethyl-hexyl; n-heptyl; n-octyl; iso-octyl; phenyl; 3-methyl phenyl; 2,4-dimethyl phenyl; isopropyl phenyl; or t-butyl phenyl; and
(iii) R³ represents n-butyl; iso-butyl; sec-butyl; tert-butyl; n-pentyl; n-hexyl; 2-ethyl-hexyl; n-heptyl; n-octyl; iso-octyl; phenyl; 3-methyl phenyl; 2,4-dimethyl phenyl; isopropyl phenyl; or t-butyl phenyl.

7. The composition of claim 6 wherein the phosphoric ester is selected from: tris-(2-ethyl-hexyl)phosphate; tri-n-octyl phosphate; tri-iso-butyl phosphate; and mixtures thereof.

8. The composition of claim 1 wherein the formulation does not include a second solvent.

9. The composition of any one of the preceding claims further comprising at least one other solvent selected from the group consisting of: aromatic organic solvents; paraffins; alcohols; esters; mineral or vegetable oils; ketones; amides; sulfoxides; sulfones; and mixtures thereof, wherein the phosphoric ester is present in a concentration of from about 10 to about 80 wt % of the composition, with the proviso that the composition comprises from about 50 to about 85 wt % total solvent based on the weight of the composition, and wherein the total solvent is the combined amount of phosphoric ester plus other solvent present in the composition.

10. The composition of any one of the preceding claims further comprising a crystallization inhibitor wherein the crystallization inhibitor is an amide of the formula R⁴CONR⁵R⁶, wherein:
(i) R⁴ comprises C₅-C₁₉ saturated alkyl, C₅-C₁₉ monounsaturated alkyl, or C₂-C₁₉ saturated or monounsaturated alkyl substituted with —OH;
(ii) R⁵ comprises C₁-C₆ alkyl; and
(iii) R⁶ comprises H or C₁-C₆ alkyl.

11. The composition of claim 9 wherein the other solvent comprises a dialkyl adipate ester.

12. The composition of any one of the preceding claims further comprising a component [C] which is a fungicide selected from the group consisting of: i) azoles; ii) amino-derivatives; iii) strobilurins; iv) specific anti-oidium compounds; v) aniline-pyrimidines; vi) benzimidazoles and analogs; vii) dicarboximides; viii) polyhalogenated compounds; ix) SAR inductors; xi) acylalanines; xii) anti-peronosporic compounds; xiii) dithiocarbamates; xiv) arylamidines; xv) phosphorous acid and derivatives; xvi) fungicidal amides; xvii) nitrogen heterocycles; and mixtures thereof.

13. The composition of claim 12 wherein component [C] is selected from: (1) an azole selected from the group consisting of difenoconazole, flutriafol, epoxiconazole, prothioconazole and tebuconazole; or (2) a strobilurin selected from the group consisting of: azoxystrobin, fluoxastrobin, kresoxim-methyl, picoxystrobin, pyraclostrobin, or trifloxystrobin; or any combination thereof.

14. The composition of any one of the preceding claims comprising a combination of a strobilurin and an azole fungicide.

15. The composition of claim 14 comprising azoxystrobin and an azole selected from the group consisting of difenoconazole and prothioconazole.

16. The composition of claim 3, wherein fluindapyr is an enantiomeric mixture comprising R-fluindapyr and S-fluindapyr enantiomers.

17. The composition of claim 16, wherein the mixture is enriched in, or consists essentially of, R-fluindapyr.

18. The composition of any one of claims 12-17, wherein the weight ratio between component (A) and component [C] ranges from 1:20 to 20:1.

19. A method for controlling phytopathogenic fungi in agricultural crops that comprises applying an effective dose of a composition according to claim 1 on: (a) plants to be protected; and/or (b) seeds of said plants before sowing; and/or (c) soil in which said plants grow.

20. The method of claim 19 wherein the fungi are selected from fungi in the group consisting of: Basidiomycetes, Ascomycetes, Deuteromycetes or imperfect fungi, Oomycetes, Puccinia spp., Ustilago spp., Tilletia spp., Uromyces spp., Phakopsora spp., Rhizoctonia spp., Erysiphe spp., Sphaerotheca spp., Podosphaera spp., Uncinula spp., Helminthosporium spp., Rhynchosporium spp., Pyrenophora spp., Monilinia spp., Sclerotinia spp., Septoria spp. (Mycosphaerella spp.), Venturia spp., Botrytis spp., Alternaria spp., Fusarium spp., Cercospora spp., Cercosporella herpotrichoides, Colletotrichum spp., Pyricularia oryzae, Sclerotium spp., Phytophtora spp., Pythium spp., Plasmopara viticola, Peronospora spp., Pseudoperonospora cubensis, or Bremia lactucae.
